(19) United States
(12) Patent Application Publication
(10) Pub. No.: US 2008/0208763 A1
(43) Pub. Date: Aug. 28, 2008

(54) SYSTEM, METHOD AND COMPUTER PROGRAM PRODUCT FOR FACILITATING COMMERCIAL REAL ESTATE TRANSACTIONS INVOLVING PERCENTAGE OWNERSHIPS IN PROPERTIES

(76) Inventor: Jeffrey C. Smith, Fairhope, AL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/035,734

(22) Filed: Feb. 22, 2008

Related U.S. Application Data
(63) Continuation-in-part of application No. 10/890,457, filed on Jul. 13, 2004.
(60) Provisional application No. 60/891,139, filed on Feb. 22, 2007.
(60) Provisional application No. 60/565,554, filed on Apr. 27, 2004.

(51) Int. Cl. G06Q 30/00

(52) U.S. Cl. 705/80

(57) ABSTRACT

A method is provided that includes maintaining a database including information associated with a real-estate portfolio of an entity, where the real-estate portfolio includes one or more real-estate properties. The method also includes receiving selection of a property in the portfolio for offering one or more percentage ownerships thereof. An offering of one or more percentage ownerships of the respective property is initiated in response to the selection, initiating an offering including automatically notifying one or more other entities of the offering. And commitments are received from one or more other entities regarding respective percentage ownerships of the property to thereby facilitate the entity and one or more other entities concluding a percentage-ownership transaction regarding the property. As provided, the offering is retractable by the entity until the other entities commit to purchase, in the aggregate, a minimum percentage ownership of the respective property.

### CROSS-REFERENCE TO RELATED APPLICATIONS

The present application claims priority from U.S. Provisional Patent Application No. 60/891,139, entitled: System, Method and Computer Program Product for Facilitating Commercial Real Estate Transactions Involving Percentage Ownerships in Properties, filed Feb. 22, 2007; is a continuation-in-part of U.S. patent application Ser. No. 10/890,457, entitled: System, Method for Insuring an Entity Against Tenant Default with Respect to an Income-Producing Property, filed on Jul. 13, 2004, and U.S. patent application Ser. No. 11/556,280, entitled: System, Method and Computer Program Product for Facilitating a Real Estate Exchange, filed on Nov. 3, 2006, both of which claim priority from U.S. Provisional Patent Application No. 60/565,554, entitled: System, Method and Computer Program Product for Facilitating Real Estate Transactions, filed on Apr. 27, 2004, the contents of all of which are incorporated herein by reference in their entireties.

### FIELD OF THE INVENTION

Exemplary embodiments of the present invention generally relate to systems and methods for coordinating a flow of information that controls the efforts of buyers and sellers to effectuate real estate transactions involving percentage ownerships in properties and, more particularly, to systems and methods for coordinating a flow of information that controls the efforts of buyers and sellers to effectuate transactions regarding percentage ownerships in commercial real estate properties.

### BACKGROUND OF THE INVENTION

In the commercial real estate industry, potential sellers of commercial real estate often avoid publicly advertising or listing their real estate, and potential sellers and buyers are often very cautious about selling or purchasing commercial real estate that has single or multiple existing tenants. Potential sellers often fear that existing tenants of affected properties will look to lease space elsewhere, and/or that potential tenants will avoid leasing space within the affected properties. Potential buyers, on the other hand, are typically reluctant to purchase property due to the risk of default of tenants leasing space within the property.

In addition, potential sellers typically prefer to not be “shopped” by competitors, or felt out by numerous developers and/or potential buyers. Further, potential sellers typically prefer to not be limited by listing agreements or agency relationships that bind the potential sellers to a single brokerage firm or an unnecessary agency liability for a specific duration. And as a result of potential sellers avoiding public advertising or listing of their properties, in various segments of commercial real estate, the demand of available potential buyers may significantly outnumber the supply of known, publicly available properties. However, this generally does not reflect the fact that the demand of available potential buyers significantly outnumbers the supply of properties available for purchase, only that a significant number of available properties may not be publicly available, and thus known, to potential buyers.

### SUMMARY OF THE INVENTION

In light of the foregoing background, exemplary embodiments of the present invention provide an improved apparatus, method, and computer program product for facilitating real estate transactions by providing a platform for offering percentage ownerships of an income-producing property and, if desired, insuring an entity with respect to the property. As explained herein, percentage ownerships in a property may be offered, sold, purchased, exchanged or the like. It should be understood, however, that percentage ownership in a property may be referenced in any of a number of different manners to reflect less than full ownership in a property, including fractional ownership, tenancy-in-common (TIC) ownership or the like.

By offering percentage ownerships of an income-producing property and insuring an entity with respect to the property, the platform of exemplary embodiments of the present invention may create a new financial asset class having greater liquidity and transparency than existing asset classes, including stock assets, and may convert such assets from a mandatory long-term hold to a possible short term hold. This new financial asset class may be stock-like in that instead of buying a share in a publicly-traded company, one may be able to invest in a share of property within which that publicly-traded company resides. But unlike a stock, this share may be backed by the bricks and mortar, the strength of the companies that are leasing and the strength of an insurance company guaranteeing at least a percentage of rental income. The increased stability and safety of this new asset class may make it a prime vehicle to allow a non-accredited investor to purchase large commercial real estate assets (properties) without the burden of ownership of the necessity of commercial real estate acumen.

This new asset class may have a percentage of rental income insured against default for a period of time, including the entire holding period of the asset. The asset may be exchange (e.g., IRS 1031 tax-deferred exchange) eligible so one may defer capital gain taxes and reinvest the full profits in another property. Property management may be generally performed by a sponsor who may, in turn, be scrutinized by an outside financial research and analysis organization, such as Standard & Poor's (S&P). In addition, this sponsor or a facilitator may report prepare, and make available, reports of property performance, so management of the income-producing property asset may have greater transparency than a stock market asset.

In addition to the foregoing, the platform of exemplary embodiments of the present invention may allow or otherwise enable one or more of the following:
Efficient alignment of industry and mainstream demand to aggregate to existing for-sale percentage-ownership properties of an increased supply base of confidentially-available but not-for-sale properties. Investors or their brokers may enter their demand criteria, which can be aggregated by a facilitator arrangement according to investor interest so that investors can then be grouped in a buyer base and aligned with the most likely property to achieve the investor goals and the transaction can much more efficiently close a with out the risk of running afoul of various time constraints;
Participation of sellers in percentage-interest increased profits without the burden or liability of ongoing asset management, which may enable REITs (real estate investment trusts) to receive increased profits of 5, 10% or more than they may otherwise be able to achieve; or
Stabilization of retirement income through an exportable model that may facilitate global financial innovation.

The apparatus, method and computer program product of embodiments of the present invention may therefore solve the problems identified by prior techniques and may provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for facilitating real estate transactions in accordance with exemplary embodiments of the present invention;

FIG. 2 is a schematic block diagram of an entity capable of operating as a buyer, seller and/or facilitator, in accordance with exemplary embodiments of the present invention;

FIGS. 3A and 3B are flowcharts illustrating various steps in a method of facilitating a real estate transaction in accordance with an exemplary embodiment of the present invention;

FIG. 4 is a flowchart illustrating various steps in a method of insuring the owner or leaseholder of income-producing property against the default of one or more tenants of such property, in accordance with an exemplary embodiment of the present invention;

FIG. 5 is a flowchart illustrating various steps in a method of facilitating commercial real estate transactions involving percentage ownerships in one or more properties, in accordance with an exemplary embodiment of the present invention; and

FIGS. 6-33 illustrate exemplary displays capable of being provided by a facilitator arrangement to buyer arrangements and seller arrangements, in accordance with exemplary embodiments of the present invention.

### DETAILED DESCRIPTION OF THE INVENTION

The present invention now will be described more fully hereinafter with reference to the accompanying drawings, in which preferred exemplary embodiments of the invention are shown. This invention may, however, be embodied in many different forms and should not be construed as limited to the exemplary embodiments set forth herein; rather, these exemplary embodiments are provided so that this disclosure will be thorough and complete, and will fully convey the scope of the invention to those skilled in the art. Like numbers refer to like elements throughout.

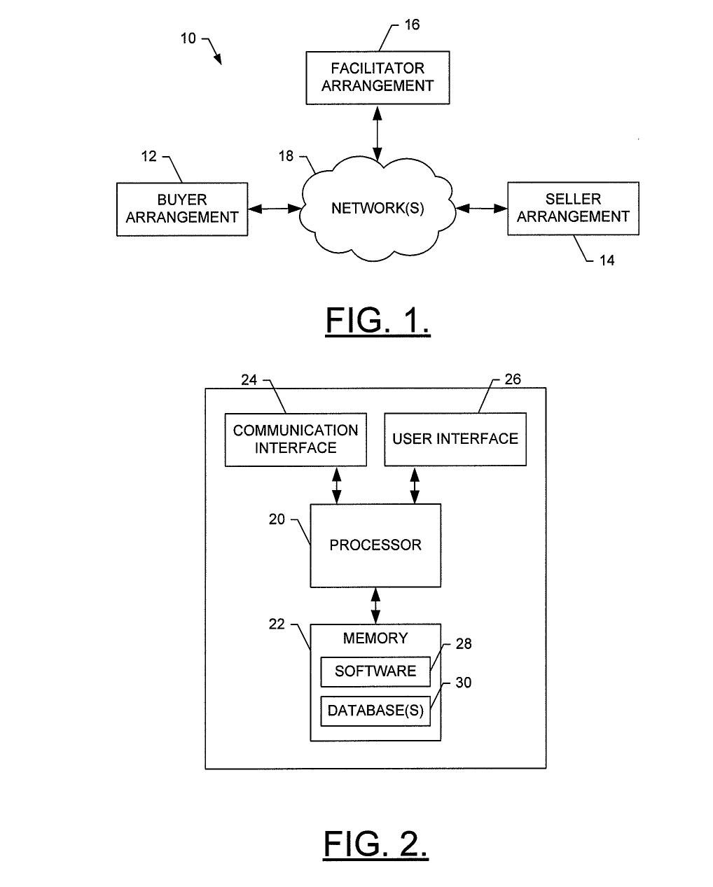

Referring to FIG. 1, a system 10 for facilitating real estate transactions includes one or more buyer arrangements 12, seller arrangements 14 and facilitator arrangements 16 (one of each being shown). Each buyer arrangement is capable of directly and/or indirectly communicating with one or more seller arrangements and facilitator arrangements. Similarly, each seller arrangement is capable of directly and/or indirectly communicating with one or more buyer arrangements and facilitator arrangements; and each facilitator arrangement is capable of directly and/or indirectly communicating with one or more buyer arrangements and seller arrangements. In this regard, the buyer, seller and facilitator arrangements can be capable of directly and/or indirectly communicating with one another across one or more networks 18. The network(s) can comprise any of a number of different combinations of one or more different types of networks. For example, the network(s) can include one or more data networks, such as a local area network (LAN), a metropolitan area network (MAN), and/or a wide area network (WAN) (e.g., Internet), and include one or more wireline and/or wireless voice networks, including a wireline network such as a public-switched telephone network (PSTN), and/or wireless networks such as IS-136 (TDMA), GSM, and/or IS-95 (CDMA). For purposes of illustration, however, as described below, the network comprises the Internet (i.e., WAN) unless otherwise noted.

The buyer arrangement 12, seller arrangement 14 and facilitator arrangement 16 can comprise any one or more of a number of different entities, devices or the like capable of operating in accordance with exemplary embodiments of the present invention. In this regard, one or more of the buyer arrangement, seller arrangement and facilitator arrangement can comprise, include or be embodied in one or more processing elements, such as one or more of a laptop computer, desktop computer, server computer or the like. Additionally or alternatively, one or more of the buyer arrangement, seller arrangement and facilitator arrangement can comprise, include or be embodied in one or more portable electronic devices, such as one or more of a mobile telephone, portable digital assistant (PDA), pager or the like. For example, the buyer arrangement, seller arrangement and facilitator arrangement can each comprise a processing element capable of communicating with one another across the Internet (e.g., network 18).

It should be understood, however, that one or more of the buyer arrangement 12, seller arrangement 14 and facilitator arrangement 16 can comprise or otherwise be associated with a user carrying out the functions of the respective entity. For example, the buyer arrangement can comprise a buyer or buyer agent (representing a buyer) communicating across a PSTN (e.g., network 18), by mail or in person with a seller operating a seller processing element, where the seller and processing element collectively comprise the seller arrangement. In such instances, the facilitator arrangement can comprise a facilitator processing element communicating across the Internet with the seller processing element. Alternatively, in such instances, the facilitator can comprise a facilitator operating a facilitator processing element, where the facilitator is capable of communicating with the seller across a PSTN. As explained below, then, the term “buyer arrangement” can refer to a buyer and/or buyer processor. Similarly, the term “seller arrangement” can refer to a seller and/or seller processor; and the term “facilitator arrangement” can refer to a facilitator and/or facilitator processor.

Referring now to FIG. 2, a block diagram of an entity capable of operating as a buyer arrangement 10, seller arrangement 14 and/or facilitator arrangement 16 is shown in accordance with one exemplary embodiment of the present invention. Although shown as separate entities, in some exemplary embodiments, one or more entities may support one or more of a buyer arrangement, seller arrangement and/or facilitator arrangement, logically separated but co-located within the entit(ies). For example, a single entity may support a logically separate, but co-located, buyer arrangement and facilitator arrangement. Also, for example, a single entity may support a logically separate, but co-located seller arrangement and facilitator arrangement. As shown, the entity capable of operating as a buyer arrangement 12, seller arrangement 14 and/or facilitator arrangement 16 can generally include a processor 20 connected to a memory 22. The processor can also be connected to at least one communication interface 24 or other means for transmitting and/or receiving data, content or the like. The processor can additionally be connected to a user interface 26 that can include a display and a user input interface. The user input interface, in turn, can comprise any of a number of devices allowing the entity to receive data from a user, such as a keypad, a touch display (not shown) or other input device.

The memory 30 can comprise volatile and/or non-volatile memory, and typically stores content, data or the like. In this regard, the memory typically stores software applications 28, instructions or the like for the processor to perform steps associated with operation of the entity in accordance with exemplary embodiments of the present invention. For example, the memory can store software applications such as one or more connectivity applications (e.g., Web browser, etc.). Also, when the entity comprises a facilitator arrangement 16, the memory can store one or more databases 38, such as a buyer database and a property database. The buyer database can store information relating to buyers registered with the service offered by the facilitator arrangement, and the property database can store information relating to sellers and associated properties that are registered with the service. As explained herein, buyers and sellers may individually or collectively be referred to as participants of the service offered by the facilitator arrangement. And while the associated properties may be concurrently listed with the facilitator arrangement service and one or more other services, such as the Multiple Listing Service (MLS), in one exemplary embodiment of the present invention, the associated properties are listed with the facilitator arrangement service in lieu of a listing with other services.

In accordance with exemplary embodiments of the present invention, the facilitator arrangement 16 is capable of offering a real estate information exchange service to one or more buyer arrangements 12 and seller arrangements 14. Generally, the service provides a medium for buyers and sellers to communicate with one another without outside interference to facilitate the respective arrangements concluding a real estate sales or exchange transaction. And since buyers are typically reluctant to purchase property due to the risk of default of tenants leasing space within the property, if so desired, the service can also provide, for a period of time, insurance to the buyer against loss of income due to default of the existing tenants of the property, should a buyer and seller conclude the purchase/sale of a property. As described herein, such insurance may be referred to as “tenant default insurance.”

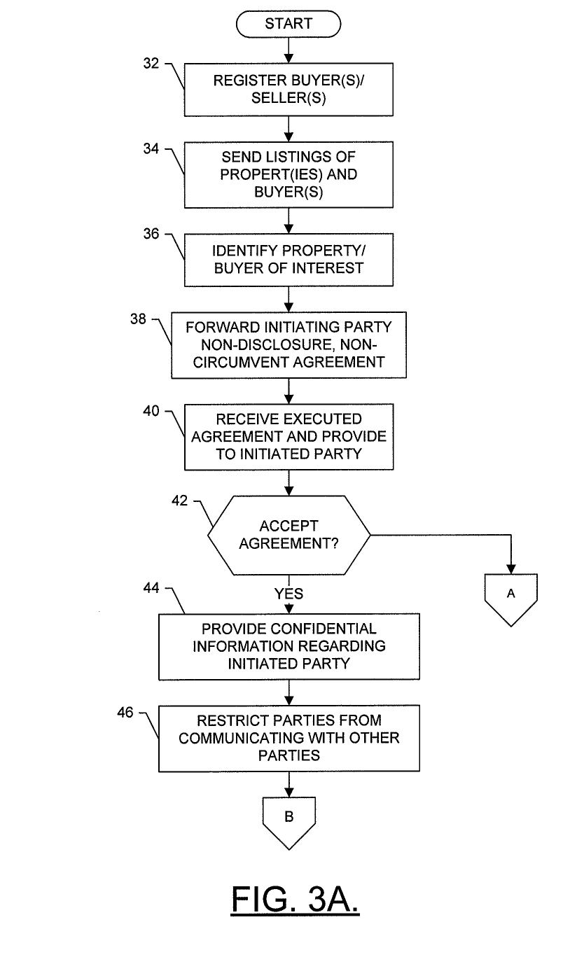

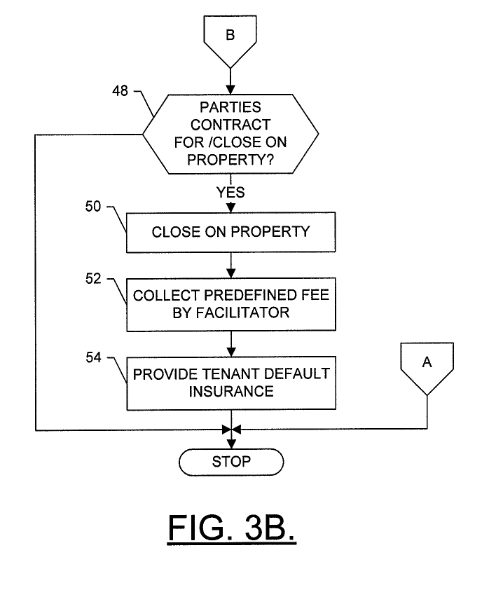

Reference is now made to FIGS. 3A and 3B, which illustrates various steps in a method of facilitating a real estate transaction, such as to effectuate the sale of a property in its entirety or in percentages (explained further below), in accordance with one exemplary embodiment of the present invention. As shown in block 32, the method can include the one or more buyers and sellers of the buyer arrangements 12 and seller arrangements 14, respectively, registering with the facilitator arrangement 16, or more particularly with the service offered by the facilitator arrangement. Advantageously for the sellers, during the registration process of the buyers, information regarding the buyers can be generated, gathered or otherwise received by the facilitator arrangement. For example, the facilitator arrangement can gather information regarding the type of buyer (e.g., cash, joint venture, exchange, etc.), property purchases made by the buyer arrangements over a previous period of time (e.g., previous 12-24 months). The facilitator arrangement can then evaluate such buyer information to determine if the buyer information is accurate to thereby determine if the buyers are legitimate. For example, the facilitator arrangement can evaluate information regarding property purchases made by the buyer to determine the nature of the financing used to purchase the properties (e.g., all cash, mortgage, owner financing, equity trade, etc.). In addition, the facilitator arrangement can evaluate the buyer information to determine if the buyers are qualified to purchase an indicated level of real estate. In this regard, if the facilitator arrangement fails to determine that the buyers are legitimate and qualified, the facilitator arrangement can refuse to register the respective buyers. Otherwise, the facilitator arrangement can register the buyers with the service offered by the facilitator arrangement.

For the buyers, information regarding the properties of the sellers and/or the sellers themselves can be generated, gathered or otherwise received by the facilitator arrangement 16. The facilitator arrangement can then evaluate such seller information to allow the facilitator arrangement to provide data related to the properties. For example, the facilitator can receive and thereafter evaluate or otherwise confirm seller information including blueprints, aerial photos, zoning, certificates of occupancy, various regulatory approval letters, rent rolls, lease abstracts, parking ratios, setbacks, surveys, inspections, NOIs (net operating incomes), cap (capitalization) rates, appraisals, electronic property operating data (EPOD), EPOS-prop operating statements, deeds, mortgage information, financing packages, cash-on-cash projections, cash flow projections, comparables by radius, competition reports with tenant mix and local trend reports, as well as property specific mapping of income, population, consumer expenditure, retail sales and crime statistics.

In addition to the foregoing, the facilitator arrangement can receive, from one or more of the participants (e.g., one or more buyers and sellers of the buyer arrangements 12 and seller arrangements 14), information regarding the supply of properties owned by the participants, as well as the demand (and/or anticipated demand) for properties by the participants. In this regard, the participants may provide, to the facilitator arrangement, their asset base of properties including asset base criteria characterizing those properties such as, for example, property type, region, price range and/or quantity. Additionally or alternatively, participants may provide their acquisition criteria for a current time period (e.g., year) and/or one or more future time periods, where the acquisition criteria characterizes for properties the respective participants anticipate purchasing (including those that the participants anticipate purchasing or otherwise desire to purchase) during the respective time period(s). Similarly, additionally or alternatively, participants and sellers may provide their disposition criteria for a current time period (e.g., year) and/or one or more future time periods, where the disposition criteria characterizes properties of the respective participants that the respective participants anticipate selling during the respective time period(s). In this regard, the disposition criteria for one or more properties of a participant may match the asset base criteria for those properties. Thus, from an asset base of properties each including asset base criteria, the asset base criteria for one or more properties the participant anticipates selling may be provided as disposition criteria for that participant.

The acquisition criteria and disposition criteria can be provided in any of a number of different manners, such as by performing searches of buyer arrangements and/or properties in the buyer database and/or property database (i.e., databases 38). The acquisition and disposition criteria can include any of a number of different criteria, and may be the same or different. In one exemplary embodiment, for example, the acquisition and disposition criteria are the same and may include one or more of property type, region, price and/or price range, cap rate, quantity and/or percentage ownership. Additional information such as percentage occupancy, percentage of national tenancy, average lease terms remaining, location, MSA (metropolitan statistical area) or other market size, average remaining lease term, total square feet, acreage, number of parking spaces, year built, year of last renovation, traffic count, and/or demographic variables may be coded or entered as searchable field data enabling the searcher to broaden or narrow their search, alignment or correlation of the acquisition and disposition criteria.

After providing such information regarding an asset base, the facilitator arrangement 16 can provide, to the participants, a real-time forecast of industry projected purchases and/or sales based on total aggregation of the participants' acquisition criteria and/or disposition criteria, and/or the number of properties having matching respective criteria. This breakdown may be respectively referred to as “industry” supply and demand, and may forecast performance for a particular time period (e.g., year). Such information may be used, for example, as a rule of thumb for entities such as pension funds to make funds available for institutional buyers. Further, for-sale (or for-sale or held) properties including particular asset base criteria in the asset bases of the participants may show immediate, current real-time supply for properties with matching asset base criteria, and active searches by participants for properties including particular acquisition criteria may show immediate, current real-time demand for properties with matching acquisition criteria. This breakdown may be respectively referred to as “current” supply and demand. As explained herein, the terms “match,” “matching,” matches” or the like may be interpreted to encompass not only a complete match, but may additionally or alternatively include a substantial match. In this regard, a substantial match may include a match of a particular percentage (e.g., 70%), and/or a match of one or more particular pieces of information (e.g., property type, region, price range and/or cap rate) in a collection of information (e.g., asset base criteria).

More particularly, the facilitator arrangement 16 can provide, to a participant, real-time information regarding the number of properties in the asset bases of other participants having matching asset base criteria with the properties in the respective participant's asset base (industry assets). For example, a participant with an asset base including a property with certain asset base criteria may receive real-time information regarding the number of properties in the asset bases of other participants that match that certain asset base criteria. The facilitator arrangement can also provide, to a participant, real-time information regarding the number of properties having acquisition criteria (other participants anticipate purchasing) matching the asset base criteria of properties in the respective participant's asset base (industry demand), and/or real-time information regarding the number of properties having acquisition criteria matching the disposition criteria of the respective participants. For example, a participant with an asset base including a property with certain asset base criteria may receive real-time information regarding the number of properties (other participants anticipate purchasing) having acquisition criteria that match that certain asset base criteria. In addition, the facilitator arrangement can provide, to a participant, real-time information regarding the number of properties having disposition criteria (other participants anticipate selling) matching the asset base criteria of properties in the respective participant's asset base (industry supply).

The supply and/or demand may be broken down to provide information as to the number of matching properties in the collective asset bases, those having matching acquisition criteria, in a “hold” state, in a “for sale” state, and/or in an “engaged” state (the respective states being explained in greater detail below), and/or the number of historical sales of properties of the participants. The matching collective properties in the asset bases that are in the “for sale” state (or in either the “for sale” state or “engaged” state) may constitute current supply, and the properties that are in either the “hold” state or the “for sale” state that match active searches for similar properties may constitute current demand. As described herein, although information may be provided in real-time as that information is received, generated or the like, it should be understood that such information may alternatively be provided in a manner other than real-time, such as at one or more instances per a given time period (e.g., once per day).

The facilitator arrangement 16 may provide the aforementioned asset, supply and/or demand information to the participants in any of a number of different manners. For example, the facilitator arrangement may provide the number of instances of matching properties, matching acquisition criteria and/or matching disposition criteria adjacent to, or in a manner otherwise associated with, the respective properties of the participants. Thus, with this information, buyers and sellers are apprised, in real time, of the demand and/or supply for properties similar to the properties in their asset bases (as identified by the respective criteria).

As explained above, the facilitator arrangement 16 can provide, to a participant, information regarding the assets or asset bases of other participants. It should be understood, however, that the facilitator arrangement may additionally or alternatively provide, to a participant, information as to the number of matching properties in the collective asset bases of, those having matching acquisition criteria for, and/or those having matching disposition criteria for, all of the participants (including the respective participant and other participants).

Once in the asset base or any of the states within which a property may be placed (e.g., “hold” state, “for sale” state, etc.—explained below), the respective participant can adjust one or more criteria related to the property (e.g., reduce the cap rate), such as to measure demand for the property with different criteria. The participant can therefore determine a real-time value of the property based on the real-time demand for the property with specific criteria (e.g., at a specific price). More particularly, for example, consider a participant with an asset base including a property with certain asset base criteria, including a certain cap rate. In this regard, the cap rate may be searched or assessed by viewing additional criteria such as percentage occupancy, average remaining lease terms, market size, or certain demographic variables, for example. Also consider that the buyer database includes a particular number of buyer arrangements 12 with acquisition criteria matching the asset base criteria of the respective, thereby providing a measure of current demand for that property. In such instances, the participant may adjust one or more asset base criteria of the property, such as by adjusting the cap rate. In response, the service of the facilitator arrangement 16 may adjust the current demand to now reflect the number of buyer arrangements with acquisition criteria matching the adjusted asset base criteria. The participant may adjust the asset base criteria of the property at one or more instances. Accordingly, the participant may perform a real-time valuation of the property by identifying the number of interested buyers (those with matching acquisition criteria) for the property with different asset base criteria values.

As information regarding properties of the sellers is generated, gathered or otherwise received, the respective sellers or seller arrangements 14 may designate their properties as being in one of a number of different states, such as in a “hold” state or “for sale” state. In this regard, properties in the “for sale” state may be listed by the facilitator arrangement as being properties available for engagement in a real estate transaction, such as a real estate sale or exchange. Properties in the “hold” state, on the other hand, may be evaluated by the facilitator arrangement 16, but not otherwise listed as being available for engagement. At such time that the respective seller arrangement desires to list a held property for sale, the seller arrangement may merely move the property from the “hold” state to the “for sale” state, with the property already having been evaluated. Properties in the “hold” and/or “for sale” states may indicate, in real time, the number of buyers interested in similar properties (as identified by, e.g., matching asset base and acquisition criteria), and if so desired, also identify the types of interested buyers, such as cash, joint venture or exchange-type buyers (identified based on buyer information). Accordingly, the facilitator arrangement may triggered to notify buyer arrangements 12 of “for sale” properties as the respective seller arrangements change the state of those properties from “hold” to “for sale,” as explained below.

Before, after or as the facilitator arrangement 16 evaluates the buyer information or seller information, the facilitator arrangement can create an entry for the buyer or the seller in the buyer database or property database. Also, in accordance with the service provided by the facilitator arrangement, the facilitator arrangement can send the buyer arrangements 12 details of the for-sale properties of sellers stored in the property database (i.e., properties in a for-sale state), and send the seller arrangements 14 details of buyers stored in the buyer database (i.e., buyers available for purchasing one or more properties), as shown in block 34. In this regard, the details of properties and buyers can be sent to the buyer arrangements and seller arrangements, respectively, in any of a number of different manners. For example, upon registering with the service provided by the facilitator arrangement, the facilitator arrangement can send the buyer and seller arrangements currently active property and buyer details maintained in the property and buyer databases. Thereafter, as properties or buyers of interest to the buyer arrangements or seller arrangements are made available, such as by being entered into a respective database, the buyer arrangements or seller arrangements may receive a real-time availability alert notifying the respective arrangements of the newly available properties or buyers. The availability alert can be received in any of a number of different manners, such as by email, short message service (SMS), notification on a Web portal of the service or the like.

The real-time availability alert may also be filtered to limit its recipients. For example, the availability alert may be filtered by the sender so that only certain receivers may receive the alert. Also, for example, the availability alert may be filtered so that only principals can receive the alert followed by brokers a period of time later. Further, for example, the availability alert may be filtered so that only certain company types or companies of a certain size, or companies having a certain historical purchasing pattern, receive the alert.

As indicated above, properties may be maintained in the property database of the facilitator arrangement 16 in a hold state whereby the respective properties are not indicated as being available for engagement in a real estate transaction (it should be understood, however, that the foregoing may be equally applicable to buyers maintained in the buyer database). Properties in the hold state, however, have a number of characteristics viewable to the respective seller arrangement including, for example, the property type, cap, and region. In addition, properties in the hold state may also have associated therewith, and viewable to the respective seller arrangement, information such as the number of potential buyers (e.g., cash, exchange or joint-venture buyers) interested in purchasing properties having one or more characteristics of the respective properties. The seller arrangements 14 of the held properties or buyers may maintain the respective held properties until such time as the seller arrangements desire to make their properties available for engagement in a real estate transaction. The respective seller arrangement can then indicate their desire by moving the held property or buyer from a hold state to a for-sale state. In response to a property being moved from a hold state to a for-sale state (or otherwise being added to the respective database), the facilitator arrangement can then, in real-time or otherwise, send availability alerts to the buyer arrangements to thereby notify the buyer arrangements of the newly available property. As will be appreciated, the hold state not only permits the seller arrangement to take a property from being totally confidential to for-sale, but may also permit the seller arrangement to take a property from being totally confidential to an “engaged” state (and even have an upstream buyer in-hand for an exchange) without the respective property ever having been placed in the for-sale state. Moreover, and as indicated above, the hold state may further permit the participant to view real-time supply and/or demand information for those or similar properties.

Properties can be made available to the marketplace in varied states of exposure, such as totally or partially confidential, fully publicly-identified, or the like. For example, properties may be made partially confidential by allowing only certain possible responders (buyers) to see limited information about the property. In this regard, a seller arrangement 14 can direct the facilitator arrangement 16 to only send out an availability alert only to certain buyer arrangements 12. These buyer arrangements may include, for example, public REITs who have assets of at least one billion dollars, have purchased this type of asset in the past. Along with directing availability alerts only to certain buyer arrangements, the seller arrangement may additionally or alternatively direct the facilitator arrangement to permit buyer arrangements to see additional property criteria such as for example, MSA or city, or perhaps the exact address.

Irrespective of how or when the buyer arrangements 12 and seller arrangements 14 receive details of properties and buyers, the details can include any of a number of different pieces of seller information and buyer information, respectively. In one exemplary embodiment, for example, the details of properties and buyers include a portion of the seller and buyer information sufficient to allow the buyers and sellers to gauge an interest in one or more properties of the sellers or one or more buyers, respectively. To facilitate the buyers and sellers engaging the service of the facilitator arrangement 16, however, the details may not include information sufficient to permit the buyers or sellers to contact one another independent of the service.

After receiving the respective details at the buyer arrangements 12 and seller arrangements 14, the buyers can identify properties of interest, and the sellers can identify buyer arrangements of interest, as shown in block 36. If either a buyer or seller (i.e., the initiating party) desires to contact a seller or buyer (i.e., the initiated party), directly or as a result of actions of the facilitator arrangement, the facilitator arrangement can forward the initiating party arrangement a non-disclosure, non-circumvent facilitation fee agreement in which the initiating party agrees to pay the facilitator arrangement a predefined fee for the service provided by the facilitator arrangement should the initiating party and initiated party conclude a real estate transaction with one another, as shown in block 38.

After the initiating party (i.e., buyer or seller) executes the non-disclosure, non-circumvent facilitation agreement, and the initiating party arrangement (i.e., buyer arrangement 12 or seller arrangement 14) returns the executed agreement to the facilitator arrangement 16, the facilitator arrangement can forward the agreement to the initiated party arrangement (i.e., seller arrangement or buyer arrangement) for acceptance by the initiated party (i.e., buyer or seller), as shown in block 40. Provided the initiated party accepts the agreement (see block 42), the facilitator arrangement can provide, to the initiating party arrangement, confidential, access-restricted information related to the initiated party, as shown in block 44. The confidential information can be provided in any of a number of different manners, such as by forwarding the initiating party arrangement a password permitting the initiating party arrangement to access the confidential information. For example, the facilitator arrangement can permit a buyer arrangement to access confidential information comprising one or more pieces of seller information regarding the seller and/or the seller's property of interest to the buyer arrangement. The access-restricted seller information and buyer information can include any of a number of different pieces of information, including contact information for the seller and buyer, and one or more of the pieces of seller information and buyer information indicated above. However, at least a portion of the confidential information typically comprises information not having been included in the details previously sent to the buyer arrangement and seller arrangement (see block 34).

Irrespective of the confidential information provided to the initiating party arrangement, after the parties are engaged with respect to a particular property, the property can be moved into an “engaged” state, or be further associated with such a state (e.g., in addition to the for-sale state). Also, once the initiating and initiated parties are engaged in communication, the parties can be restricted from contacting other parties (i.e., other sellers and buyers) for a predefined engagement period (e.g., twenty-one days), which may or may not be extendible (e.g., mutually extendible). In this regard, the parties can be considered engaged in communication in any of a number of different manners. For example, the parties can be considered engaged in communication once the initiated party accepts the non-disclosure, non-circumvent agreement, or once the initiated party receives the password or uses the password to access information related to the initiated party, as shown in block 46. Irrespective of when the parties are considered engaged in communication, during the engagement period, the buyer can be restricted from communicating with other sellers regarding other properties. Likewise, the seller can be restricted from communicating with other buyers regarding the same property during the engagement period. The parties can be restricted from communicating with other parties in any of a number of different manners. For example, the facilitator can contractually restrict the parties from communicating with other parties. Additionally or alternatively, for example, the facilitator arrangement can remove, or otherwise restrict access to, the parties from the details of properties and buyers sent to other buyer arrangements 12 and seller arrangements 14 (see block 34). Advantageously, restricting each party from communicating with other parties during the engagement period can facilitate the parties concluding a real estate transaction with one another without outside interference.

If so desired, a seller arrangement 14 can further decide to allow multiple engagements (buyer arrangements 14), such as in the form of permitting multiple engages to “bid” on the property at the end of an engagement period. In this scenario, the multiple engages may have time and the exclusive right to pursue this property during the engagement period. This allows the buyer arrangements to align their acquisition criteria with a larger more eligible supply of properties.

After the initiating and initiated parties are engaged in communication, the parties may desire to conclude a real estate transaction regarding a property of the seller. In such an instance, the parties can conclude the real estate transaction in any of a number of different manners, such as by entering into a sales contract regarding a respective property and closing on the respective property, shown in block 48. In such instances, the facilitator can operate outside the transaction, or alternatively function as a broker for the transaction. In another alternative, the facilitator can engage a broker, closing agent or other facilitator for the transaction, with the facilitator and the engaged party entering into a separate agreement related to the brokering of the transaction. In either event, at the conclusion of the transaction, such as during closing of the property, the facilitator can collect the predefined fee from the initiating party for the service provided by the facilitator, as shown in blocks 50 and 52. Also at the conclusion of the transaction, if so desired and previously offered by the facilitator, the facilitator can provide the buyer with a limited duration tenant default insurance policy, as shown in block 54 and explained below.

As explained above, the service offered by the facilitator arrangement 16 can provide, for a period of time, tenant default insurance to the buyer against loss of income due to default of the existing tenants of the property, should a buyer and seller conclude the purchase/sale of a property of the seller, even where these tenants may otherwise be judged credit-worthy by the buyer. In this regard, the facilitator arrangement can provide the buyer and seller of leasehold interest property the ability to insure income from that property against default of one or more tenants of that property under the terms of one or more leases held for that property at the time of concluding the purchase/sale of the property. As will be appreciated, the facilitator can provide the insurance as a self-insurer. Additionally or alternatively, however, the facilitator can engage a fourth party, such as an insurance carrier, to provide all or a portion of the insurance through the fourth party or in conjunction with underwriting of the fourth party.

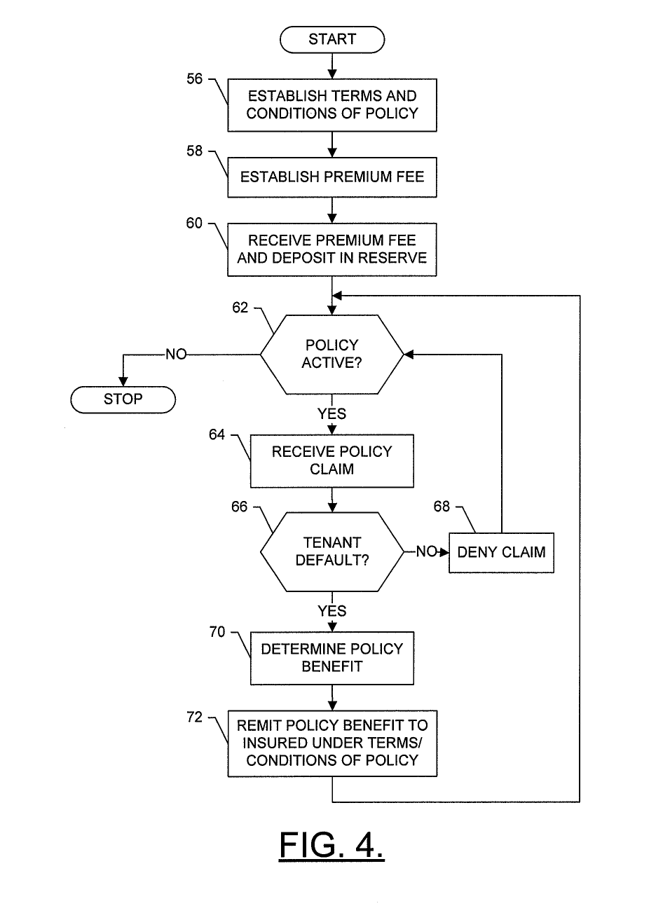

Reference is now made to FIG. 4, which illustrates various steps in a method of insuring the owner or leaseholder of income-producing property against the default of one or more tenants of such property, the property being referred to herein as the “insured property.” As shown in block 56, the method includes the facilitator arrangement 16 establishing the terms and conditions of an insurance policy under which the facilitator arrangement intends to insure the buyer or new owner of the insured property, who is also typically the leaseholder of one or more leases for the insured property or portions thereof (the buyer, owner, leaseholder also referred to herein as the “insured party”). The terms and conditions can include any of a number of different terms and conditions specific to the protection provided by the insurance policy, and if so desired, can include one or more terms and/or conditions typically offered under conventional insurance policies.

For example, the terms and conditions of the insurance policy can include a time period over which the policy is active, as well as define default of a tenant for which the policy covers loss of income. Default of a tenant can be defined in a number of different manners, such as in accordance with one of more provisions of the lease entered into by the tenant with respect to the insured property. More particularly, for example, the default of a tenant can be defined in accordance with provision(s) of the lease that relate to the financial inability of the tenant to pay rent under the terms of the lease. If so desired, default can also be defined based upon tenant holdover or occupancy during a period in which the tenant is not paying all or a portion of the rents due under the terms of the lease, against the will of the leaseholder. However, default is typically not based upon acts of God, construction delays and/or interruption of occupancy reason.

In addition to defining default of a tenant, the terms and conditions established by the facilitator arrangement 16 can include different levels of tenant default insurance, typically in accordance with a review of the financial status of the property tenancy. The levels of tenant default insurance can vary in any of a number of different manners. In this regard, the facilitator arrangement can provide tenant default insurance that covers all or a portion of the tenants of the insured property, where the covered tenant(s) may or may not be specified. Also, the facilitator arrangement can provide tenant default insurance that varies based upon the length and breadth of income protection coverage, and the percentage of income protection. The percentage of income protection, which can also correspond to the total liability or exposure of the facilitator arrangement in providing the insurance, can be determined in any of a number of different manners. In one exemplary embodiment, for example, the percentage of income protection is based upon the net operating income (NOI) of the insured property at the conclusion of the transaction. As an example, then, the facilitator arrangement can provide coverage ranging from 1% to 100% of the NOI, extending for the first twenty-four months of ownership (two years from transaction conclusion), and guaranteeing income for twelve months at any time during the first twenty-four months.

In addition, for example, the terms and conditions established by the facilitator arrangement 16 can require the insured party to evict a defaulting tenant, typically for non-payment of rent. Further, the terms and conditions can include a number of rights reserved by the facilitator arrangement with respect to the insured party, and/or the insured property. For example, the terms and conditions can include rights reserved by the facilitator arrangement such as the right to (a) re-lease and or be paid to re-lease the vacated, insured property or portion thereof immediately upon tenant default, (b) insure only the leasehold interest in place at time of property acquisition by the insured party, (c) determine the time, time period and extent of coverage, (d) refuse to offer or discontinue service or coverage under the policy for any reason, (e) to offer coverage for any property for which there is a leasehold interest created, (f) offer this service on all or a portion of the tenancy of a given property, (g) sue for damages and expenses if the facilitator arrangement determines that the default was unnecessarily constructed for the financial gain of tenant and/or insured party, (h) deny coverage if the tenant and insured party are related, in business together, have any financial gain to or from each other as a result of tenant default, or tenant and/or leaseholder conspire or collude with any third party for the benefit of leaseholder or tenant, (i) increase, extend or modify our service or coverage on all or a part of any leasehold protection offered by the facilitator arrangement, at the sole discretion of the facilitator arrangement, (j) extend coverage through third party sources at the sole discretion of the facilitator arrangement, (k) offer coverage directly or subcontract such coverage for a fee to any legally qualified second or third party at the sole discretion of the facilitator arrangement, (l) legally offer coverage domestically or internationally, (m) terminate coverage with any secondary provider for any reason and reassign such right of coverage to another legally capable party or offer coverage directly, (n) franchise or contract with other companies to legally provide service under the policy, (o) offer service or coverage under the policy under different names in different forms, and/or (p) offer service under the policy to any leasehold interest property through various delivery mediums including the Internet (i.e., network 18).

Before, after, or as the facilitator arrangement 16 establishes the terms and conditions of the insurance policy, the facilitator arrangement can establish a premium fee for providing the insurance policy, as shown in block 58. The premium fee can be established in any of a number of different manners. For example, the premium fee can be established based upon the sales price, or open market value, of the insured property. However, to provide benefit to the insured party, the premium fee is typically less than the total coverage provided by the insurance policy. In this regard, see Table 1 below for a sampling of ten exemplary properties sold and insured in accordance with exemplary embodiments of the present invention.

TABLE 1

| | | | | | Actuarial |
|---|---|---|---|---|---|
| | CAP | Sale Price | Premium Fee | Exposure | Exposure |
| NOI ($) | Rate | ($) | (0.5%) ($) | ($) | (3%) ($) |
| 500,000 | 10 | 5,000,000 | 25,000 | 75,000 | |
| 2,000,000 | 8 | 25,000,000 | 125,000 | 300,000 | |
| 750,000 | 9 | 8,333,333 | 41,500 | 112,500 | |
| 1,000,000 | 9 | 11,111,111 | 56,000 | 150,000 | |
| 600,000 | 9 | 6,667,000 | 34,000 | 90,000 | |
| 800,000 | 9 | 8,889,000 | 44,000 | 120,000 | |
| 500,000 | 10 | 5,000,000 | 25,000 | 75,000 | |
| 950,000 | 8 | 11,875,000 | 60,000 | 142,500 | |
| 3,500,000 | 7 | 50,000,000 | 250,000 | 525,000 | |
| 1,500,000 | 8 | 18,750,000 | 93,750 | 225,000 | |
| 12,100,000 | | 150,625,444 | 754,250 | 1,815,000 | 363,000 |

As shown in Table 1, presuming coverage of 15% of the NOI and a premium of 0.5% the sales price, the premium can equal approximately one-third of the total coverage provided by the insurance policy, which also corresponds to the total liability or exposure of the facilitator arrangement 16. Although the premium fee is typically less than the total coverage (total exposure) provided by the insurance policy, the actuarial exposure of the facilitator arrangement, or the more likely exposure of the facilitator arrangement, is typically less than the premium fee. To offset the total exposure, or more particularly the total actual exposure, then, the facilitator arrangement can reinsure the actuarial exposure of the facilitator arrangement, such as with a fourth party insurance carrier. However, if during the period of the insurance policy the facilitator arrangement determines the level of insurance with the fourth party insurance carrier does or will not adequately cover the exposure of the facilitator arrangement, the facilitator arrangement can adjust the level of coverage with the fourth party insurance carrier accordingly.

The actuarial exposure of the facilitator arrangement 16 can be estimated or otherwise determined in any one of a number of different manners. For example, the actuarial exposure can be estimated based upon the historical tenant default rate of the insured property over the duration of ownership of the insured property, and the NOI of the insured property. As will be appreciated, different properties have different historical tenant default rates over the duration of ownership of the respective properties. For example, retail, office and industrial properties historically have had a 7% default rate due to tenant vacancy and credit loss (i.e., default). But since the tenant default insurance is typically only based upon tenant default, the historical default rate can be estimated to be approximately half or less than half of the total historical default rate. Thus, for example, for retail, office and industrial properties, the actuarial tenant default rate can be estimated to equal approximately 3% or less. Thus, for retail, office and industrial properties, the actuarial exposure of the facilitator arrangement can be estimated to equal 3% of the NOI of the respective properties. As shown from Table 1, then, the actuarial exposure of the facilitator arrangement can be estimated to equal approximately $363,000 (i.e., 3% of 12,100,000), which is less than the premium fee of $754,250, which is less than the total coverage or total actual exposure of the facilitator arrangement, i.e., $1,815,000.

Irrespective of how the premium fee is established, the facilitator arrangement can thereafter receive the established premium fee from the insured party, such as the buyer arrangement 12 and/or the seller arrangement 14, and deposit that premium fee in reserve, as shown in block 60. In one exemplary embodiment where the insurance policy is offered in conjunction with the sale of property, the premium fee can be received by reserving a percentage (e.g., 0.5%) of the predefined fee received from the initiating party at the conclusion of a real estate transaction between the buyer arrangement and the seller arrangement. Alternatively, the premium fee can be received from the insured party independent of a real estate transaction. In such an instance, the insured party may operate as an owner or leaseholder of the insured property. In either event, the facilitator can deposit the percentage of the predetermined fee or additional fee (i.e., the premium fee) with a fourth party, such as in a reserve account of a bank.

As or after receiving and depositing the premium fee, and while the policy is active (block 62), the insured party (e.g., buyer arrangement 12) may at one or more times receive notice that one or more tenants of the insured property have defaulted on paying rent under the terms of their lease under the terms of the policy. The insured party can receive notice in any of a number of different manners, such as by receiving notice of default directly from the tenant, and/or failure to receive a periodic (e.g., monthly) rental payment from the tenant. In such an instance, the insured party can notify the facilitator arrangement 16 of the tenant default, such as by filing an insurance claim with the facilitator arrangement, as shown in block 64. As will be appreciated, the insurance claim can include any of a number of different pieces of information including, for example, the identity of the defaulting tenant, rental income due to the insured party from the defaulting tenant, the remaining term of the defaulting tenant's lease or the like.

After receiving notification of the tenant default, the facilitator arrangement 16 can determine if the tenant has defaulted under the terms and conditions of the insurance policy, as shown in block 66. If the tenant has not defaulted under the terms and conditions of the insurance policy, the facilitator arrangement can deny the insurance claim of the insured party or otherwise refuse to remit a policy benefit to the insured party (e.g., buyer arrangement 12), as shown in block 68. Otherwise, if the tenant has defaulted under the terms and conditions of the insurance policy, the facilitator arrangement can determine a policy benefit payable to the insured party, also under the terms and conditions of the insurance policy, as shown in block 70. The policy benefit can be determined in any of a number of different manners in accordance with the terms and conditions of the insurance policy. In one embodiment, for example, the policy benefit can be determined based upon the rental income due the insured party from the defaulting tenant. For example, presume the insurance policy provides coverage of up to 15% of the NOI of the insured property. In such an instance, the policy benefit can be determined as 15% of the rental income due the insured party from the defaulting tenant, less expenses incurred by the insured party in renting the respective portion of the property to the defaulting tenant. Alternatively, the policy benefit can be determined as 15% of the difference of the NOI of the property due the insured party with the defaulting tenant and the NOI without the defaulting tenant, where the NOI can be determined based upon the periodicity with which the defaulting tenant is due rent (e.g., monthly NOI of the insured property).

After determining the policy benefit, the facilitator arrangement 16 can remit the policy benefit to the insured party (e.g., buyer arrangement 12) under the terms and conditions of the policy, such as via check, bank draft, electronic wire transfer or the like, as shown in block 72. The method can then continue for the respective tenant, such as until the active time period of the policy expires or the portion of the insured property previously occupied by the respective defaulting tenant is occupied by a new tenant. In this regard, although the defaulting tenant may be evicted from the insured property, the tenant may still be considered in default, thus resulting in a loss of income. In continuing the method, the facilitator arrangement can repeatedly determine if the respective tenant remains in default under the terms and conditions of the policy (see block 64), such as with the same periodicity (e.g., monthly) with which the respective tenant paid rent. Additionally, the facilitator arrangement can repeatedly determine the policy benefit and/or remitting the policy benefit to the insured party, such as with the respective periodicity. In any event, however, the facilitator arrangement typically does not determine if the respective tenant is in default or determine or remit the policy benefit after the time period of the policy expires or after the portion of the insured property previously occupied by the respective defaulting tenant is occupied by a new tenant.

As will be appreciated, the policy can be applied to more than one tenant of the insured property, if in accordance with the terms and conditions of the policy. More particularly, the insured property may include more than one tenant that at any given time during the time period of the policy, may default. For each tenant covered under the policy, then, the facilitator arrangement 16 can receive notification of the tenant default (see block 64), determine if the tenant has defaulted under the terms and conditions of the insurance policy (see block 66), and if the tenant has defaulted, determine and remit a policy benefit to the insured party (see blocks 70 and 72).

As explained herein, the tenant default insurance described can be provided in conjunction with a real estate transaction between a buyer arrangement 12 and a seller arrangement 14. It should be understood, however, that the tenant default insurance can be provided independent of such a transaction, without departing from the spirit and scope of the present invention. For example, the tenant default insurance can be provided to a buyer arrangement independent of the transaction between the buyer and a seller of a respective property. Alternatively, for example, the tenant default insurance can be provided to an owner of a property at any point during the ownership tenure of the owner. Also, it should be understood that the tenant default insurance can also be provided in conjunction with other investment tools such as REIT (real estate investment trust) ownership and/or IRS 1031 tax deferred exchange programs to create a new investment vehicle that offers a guarantee of a certain level of income to the new buyer during initial ownership, or during a period extending beyond initial ownership, if so provided by the facilitator arrangement.

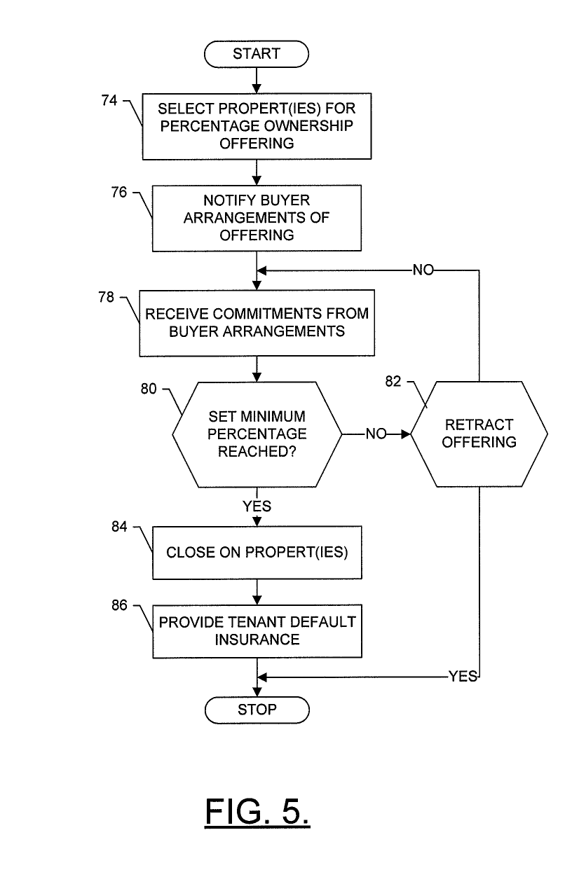

The tenant default insurance can also be provided in conjunction with tenant-in-common ownership in a property, or more generally in conjunction with percentage or fractional ownership in a property. In this regard, reference is now made to FIG. 5, which illustrates various steps in a method of facilitating commercial real estate transactions involving percentage ownerships in one or more properties, in accordance with one exemplary embodiment of the present invention. It should be understood, however, that just as tenant-default insurance may be provided independent of percentage ownerships in a property, percentage ownerships in a property may be provided independent of tenant-default insurance.

Generally, the method of facilitating commercial real estate transactions involving percentage ownerships in properties may proceed in a manner similar to that of the method shown in FIGS. 3A and 3B. Similar to before, the method can include registering buyer(s) and seller(s) of the buyer arrangements 12 and seller arrangements 14, respectively, with the facilitator arrangement 16, or more particularly with the service offered by the facilitator arrangement (see FIG. 3A, block 32). Also similar to before, then, the method can include the facilitator arrangement generating, gathering or otherwise receiving information regarding the buyers as well as information regarding the properties of the sellers and/or the sellers themselves. And again, before, after or as the facilitator arrangement 16 evaluates the buyer information or seller information, the facilitator arrangement can create an entry for the buyer or the seller in the buyer database or property database.

Referring now to FIG. 5, after registering a seller, the seller can identify or otherwise select one or more of the seller's properties (properties in the seller's portfolio) for initiating an offering of percentage ownerships of the respective propert(ies), as shown in block 74. The seller can identify the propert(ies) for the percentage ownership offering in any of a number of different manners. In this regard, the seller may identify the respective propert(ies) at the seller's own initiative. In various instances, however, the aforementioned acquisition and/or disposition criteria may have applicability in identifying one or more properties. In these instances, the facilitator arrangement 16 may be configured to aggregate acquisition criteria of various participants (e.g., accredited and/or non-accredited investors). The facilitator arrangement may then review the aggregated acquisition criteria and organize or sort groups of participants by similar acquisition criteria, and may further include numbers of participants in particular groups as may be desired or otherwise required to effectuate a percentage ownership transaction (generally or for one or more particular properties). Similarly, the facilitator arrangement may be configured to aggregate disposition criteria for various properties, and organize or sort groups of properties by similar disposition criteria. The facilitator arrangement may then align one or more groups of participants with one or more groups of one or more properties (e.g., currently for-sale properties and/or properties identified for future sale by their disposition criteria) to facilitate percentage ownership offerings and ultimate conclusion of percentage ownership transactions.

In various exemplary embodiments, identifying one or more properties may include the seller or facilitator (upon authorization of the seller) moving one or more properties from the hold and/or for-sale states to a “percentage ownership offering” state (or “Tenant-in-Common”—TIC—state in a more particular exemplary embodiment). In such instances, moving the respective propert(ies) into the percentage ownership offering state may trigger the facilitator arrangement 16 to initiate the offering, including notifying buyer arrangements 12 of the newly-available propert(ies), as shown in block 76. In this regard, the propert(ies) may be included in listings of properties sent to buyer arrangements, such as in any of a number of different manners. For example, the facilitator arrangement may send, in real-time or otherwise, availability alerts to thereby notify the buyer arrangements 12 of the newly available propert(ies) in the case of moving the property from the hold state, or further facilitate selection of the available propert(ies) in the case of moving the property from the for-sale state.

Irrespective of when or how the propert(ies) for the percentage ownership offering are identified or selected, and in addition to or in lieu of sending availability alerts, identifying respective propert(ies) may trigger a number of actions by the facilitator arrangement 16 and/or the seller arrangement 14 to effectuate the percentage ownership offering. In this regard, offering percentage ownerships in a property may require designating the propert(ies) as that having percentage ownerships, which may require preparation, execution and, if appropriate, filing a number of documents as well as making any other appropriate arrangements, such as in the context of establishing TIC ownership in a property. These documents may include, for example, necessary Security and Exchange Commission (SEC) documents; and appropriate arrangements may include, for example, arranging an outside property management firm or other entity (unless management is handled by the facilitator arrangement) to manage the property on behalf of those having percentage ownerships of the property (at times the entity performing property management functions may be referred to as a “sponsor” at least for purposes of those functions). Thus, for example, after identifying propert(ies) for a percentage ownership offering, the facilitator arrangement may communicate the seller arrangement to explain the process of designating the propert(ies) as that having percentage ownerships, and offering percentage ownerships in the propert(ies); as well as to obtain any necessary documents or execution of any necessary documents, and make any appropriate arrangements, to effectuate such ownership in the propert(ies).

To permit the seller arrangement to retract the offering should interest in the percentage ownerships be less than desired, the seller arrangement 14 and/or facilitator arrangement 16 may set a minimum percentage ownership (e.g., aggregate percentage) before which the seller arrangement may be permitted to retract the offering. Also, to permit the seller arrangement to retain a percentage ownership in the property, the seller arrangement may set a maximum percentage ownership (e.g., aggregate percentage) to be offered to buyer arrangements, where this maximum percentage may be less than one-hundred percent or may otherwise default to one-hundred percent. Further, the facilitator arrangement and/or seller arrangement may also designate a price for the property, and/or for percentage ownerships in the property. In such instances, should tenant-default insurance be offered in conjunction with the percentage ownerships, the price may be designated higher than otherwise to reflect the insurance component makes the asset more conservative and thus in greater demand by those seeking safer investments yielding lower, more conservative buyer returns.

After initiating the offering of percentage ownerships in selected propert(ies), the facilitator arrangements, including notifying buyer arrangements 12 of the newly available propert(ies), the seller arrangement 14 may receive commitments from one or more buyer arrangements for percentages of the selected propert(ies), such as directly from buyer arrangement(s) or indirectly via the facilitator arrangement 16, as shown in block 78. These commitments may be received in a number of different manners. In one embodiment, for example, one or more buyer arrangements may engage the propert(ies) for acquiring particular percentages of the respective propert(ies).

The properties can be engaged in any of a number of different manners, such as in a manner similar to that of the method of facilitating a real estate transaction explained above with respect to FIGS. 3A and 3B. More particularly, for example, the seller arrangement 14 (i.e., initiated party) can receive a non-disclosure, non-circumvent facilitation agreement from the facilitator arrangement 16, where the agreement has been executed by a buyer arrangement (i.e., initiating party) desiring to contact the seller arrangement with respect to a percentage of the propert(ies) (see FIG. 3A, block 40). Provided the seller arrangement accepts the agreement (see block 42), the facilitator arrangement can provide, to the respective buyer arrangement, confidential, access-restricted information related to the seller arrangement (see block 44). In the context of acquiring a percentage ownership in a property, this information may further include any documents that may be desired or otherwise required to effectuate such ownership in the propert(ies), such as appropriate SEC documents and/or information related to the property management firm or other entity (unless management is handled by the facilitator arrangement) selected to manage the propert(ies) on behalf of those having percentage ownerships of the propert(ies).

Once engaged in communication, the seller arrangement can receive a formal (e.g., contractual) commitment for the buyer arrangement to acquire a percentage ownership in the property, which may be accompanied by escrowing funds of the buyer arrangement until close of the appropriate transaction involving the respective percentage ownership. In contrast to before where the parties may be restricted from contacting other parties regarding the same respective property for a predefined engagement period (see block 46), the seller arrangement may be permitted to contact other buyer arrangements regarding other percentages of the property. This access to other buyer arrangements, however, may be withdrawn, and the seller arrangement restricted from communicating with other buyer arrangements, once the seller arrangement is engaged with buyer arrangements desiring to acquire, in the aggregate, one-hundred percent ownership in the property or the set maximum percentage ownership in the property, whichever is less.

In addition to or in lieu of receiving commitments directly from a buyer arrangement 12, the seller arrangement 14 may receive one or more commitments indirectly via the facilitator arrangement 16. In such instances, the facilitator arrangement may perform a number of the aforementioned functions of the seller arrangement, such as by receiving a buyer arrangement-executed non-disclosure, non-circumvent facilitation agreement; and providing, to the respective buyer arrangement, confidential, access-restricted information related to the seller arrangement. The facilitator arrangement may then receive a formal (e.g., contractual) commitment for the buyer arrangement to acquire a percentage ownership in the property.

The seller arrangement 14 may continue to enter into formal commitments for additional buyer arrangements 12 until the seller arrangement has committed, in the aggregate, one-hundred percent ownership in the propert(ies) or the set maximum percentage ownership in the propert(ies), whichever is less. In various instances, however, interest in the propert(ies) from buyer arrangements may be less than that desired by the seller arrangement. In such instances, before committing to the set minimum percentage ownership in the propert(ies), and thus before committing one-hundred percent or the set maximum percent ownership, the seller arrangement may retract the offering, as shown in blocks 80 and 82. In this regard, the seller arrangement may retract the offering, or at least initiate retraction of the offering, in any of a number of different manners. In one embodiment, for example, the seller arrangement may retract the offering, or at least initiate retraction of the offering, by moving the propert(ies) from the percentage ownership state back to the hold state or the for-sale state.

Once the seller arrangement 14 has received commitments for a sufficient percentage ownership in the propert(ies), the seller arrangement and committed buyer arrangement(s) 12 may close one or more real estate transactions regarding the respective percentages of the propert(ies) of the seller arrangement, as shown in block 84. This percentage may typically be greater than the set minimum percentage, but it should be understood that, if so desired, the seller arrangement may choose to close transactions for those percentages for which the seller arrangement has commitments even if the set minimum percentage has not yet been reached. Irrespective of exactly when the transaction(s) are closed, if so desired and offered by the facilitator, the facilitator can provide the percentage owners (including, e.g., the seller arrangement if retaining a percentage ownership in the propert(ies) with a tenant default insurance policy, as shown in block 86 and explained above.

Further, it should be understood that after acquiring a percentage ownership in one or more properties, an owner may sell, exchange or otherwise transfer all or a portion of the respective percentage to other entities (e.g., buyer arrangements). Thus, it should be understood that percentage ownerships (and, if desired, any accompanying tenant default insurance) may be bought, sold, exchanged or otherwise transferred from one entity to another. In this manner, percentage ownerships in properties may function in a manner similar to shares of a publicly-traded stock. Further, as indicated above, the addition of tenant-default insurance may make investment in the propert(ies) more conservative and thus in greater demand by those seeking safer investments yielding lower, more conservative buyer returns.

This new investment vehicle with a new aftermarket may therefore formulate a new exchange whereby sponsors may purchase or otherwise acquire exchange seats for eligibility to participate in the aforementioned services. These exchange seats, then, may include multiple shares to permit or otherwise facilitate the sponsors extracting greater value of their seat as the exchange demand increases.

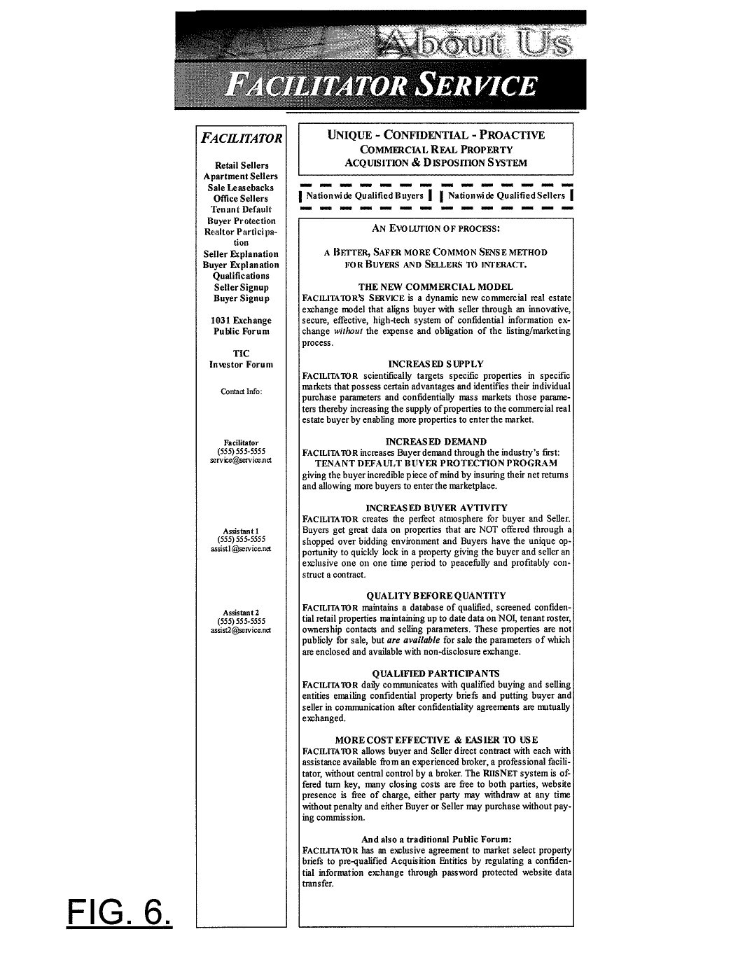

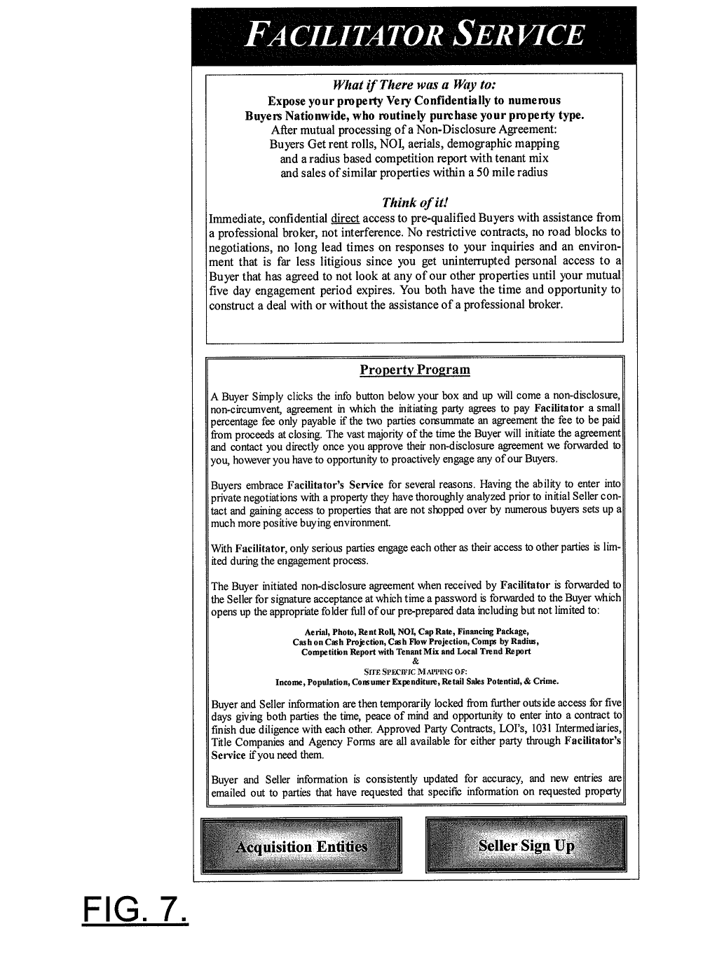

To further illustrate the benefits of the present invention, reference is now made to FIGS. 6-33, which illustrate exemplary displays, such as Web pages, capable of being provided by the facilitator arrangement 16 to the buyer arrangement 12 and/or seller arrangement. In this regard, although various ones of the displays and other figures include language further illustrating exemplary embodiments of the present invention, such language should not be taken to limit the spirit and scope of the present invention. The displays may be provided across the Internet (e.g., network 18), and thereafter presented by the respective arrangement for display to the buyer and/or seller. More particularly, as shown in FIG. 6, the facilitator arrangement can provide a portal that can explain the service offered by the facilitator arrangement, and include a number of links to other displays that permit the buyer arrangement and/or seller arrangement to engage the service. For example, the display of FIG. 6 can include a link to “Seller Explanation,” “Buyer Explanation” and “Program Qualifications” displays, which direct the facilitator arrangement to provide the displays of FIGS. 7, 8 and 9, respectively.

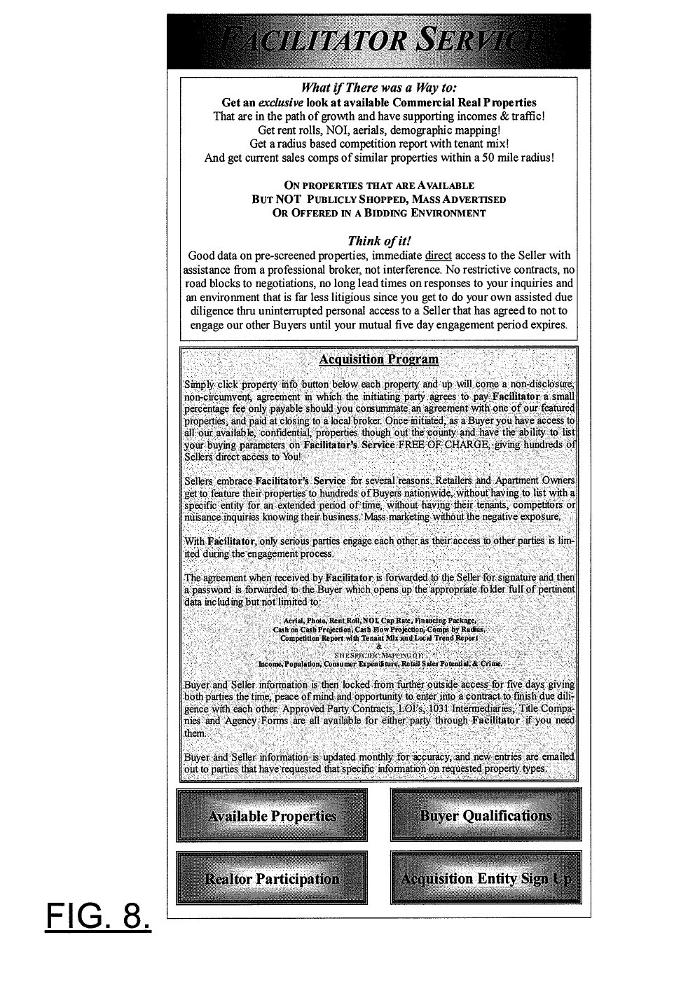

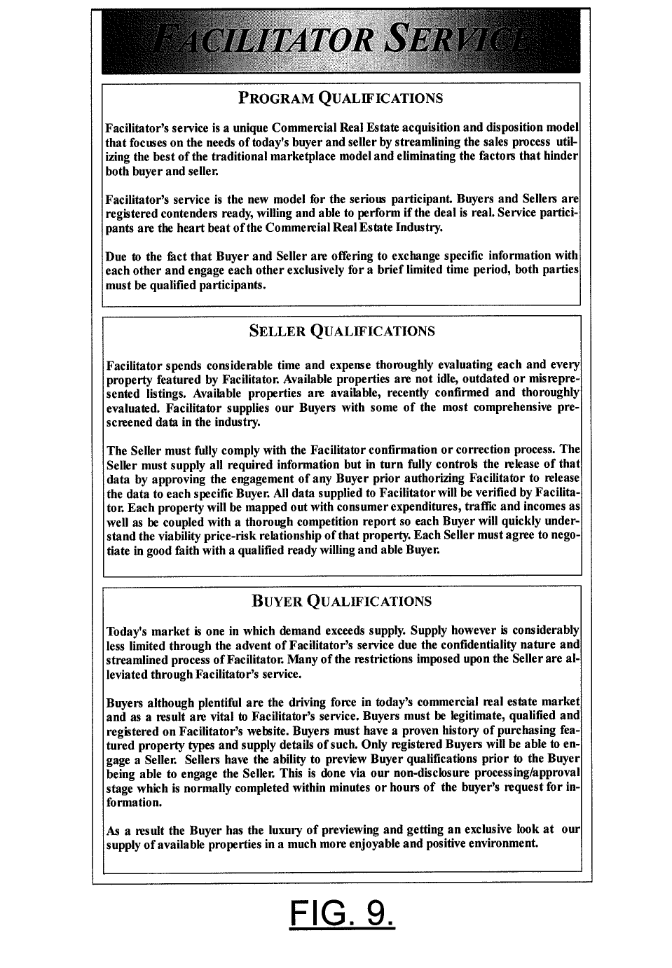

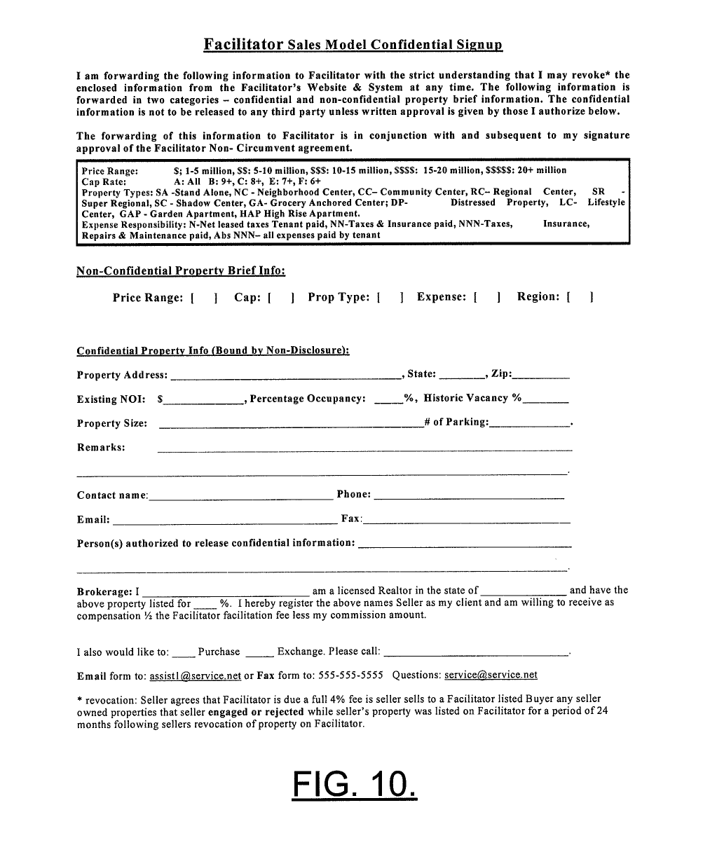

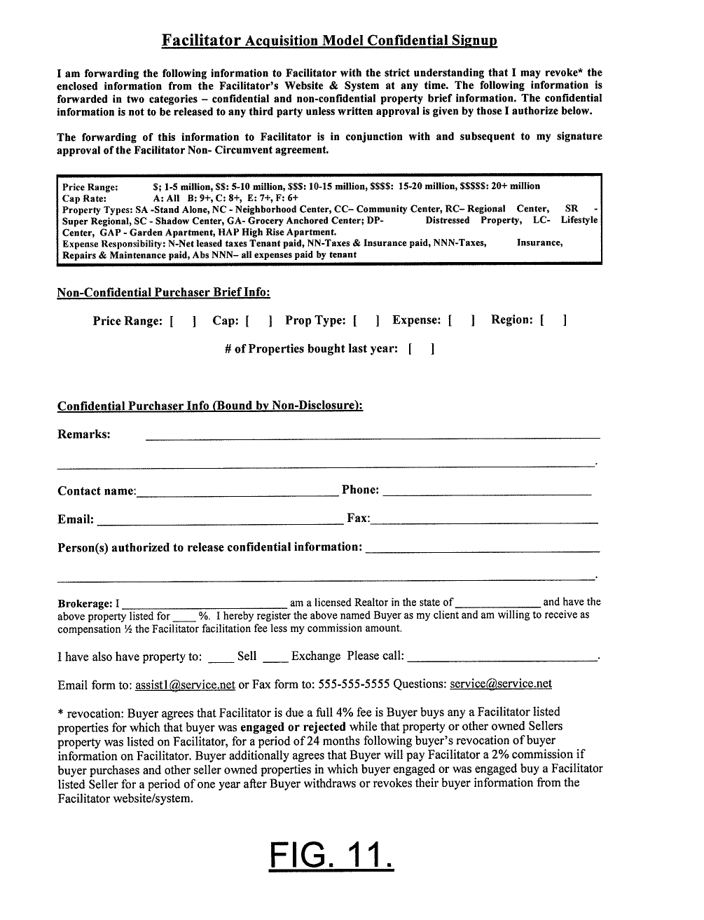

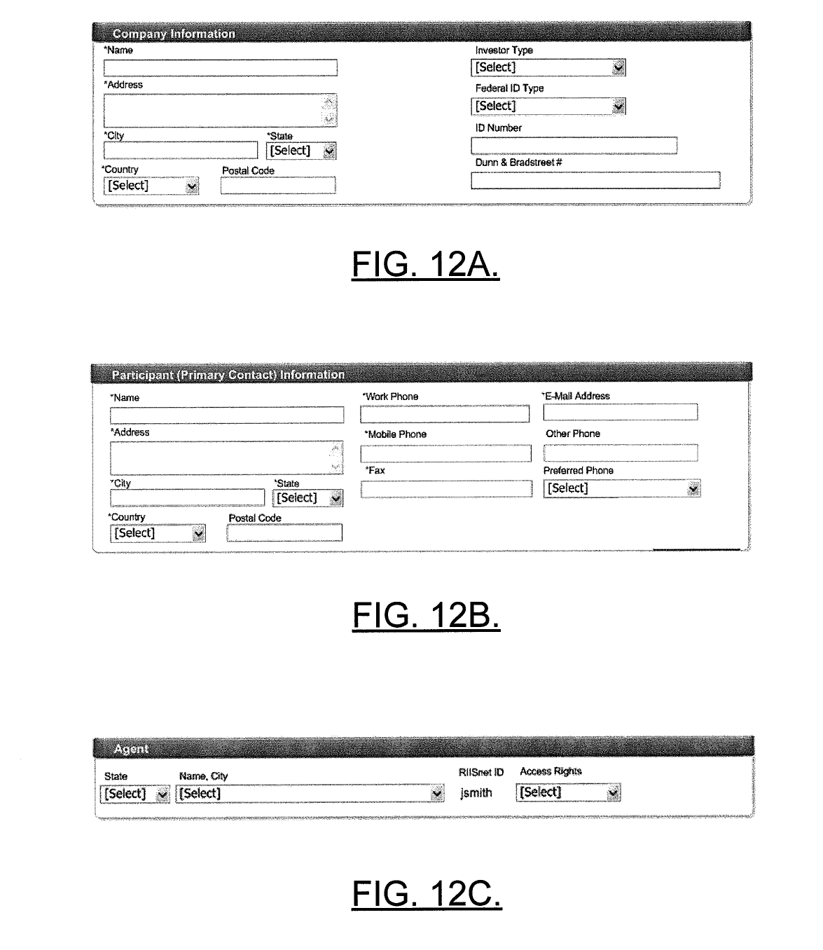

FIG. 7, then, illustrates a display that explains the service offered by the facilitator arrangement 16 to seller arrangements 14, and FIG. 8 illustrates a display that explains the service offered to buyer arrangements 12. FIG. 9, on the other hand, illustrates a display that explains the qualifications of the program or service, as well as that of seller arrangements and buyer arrangements participating in the program or service. In addition, the displays of FIGS. 7 and 8, as well as the portal display of FIG. 6, can include a link to permit a seller arrangement or a buyer arrangement to register with the facilitator arrangement, or more particularly with the service offered by the facilitator arrangement (see block 32 of FIG. 3A). Should a seller arrangement or buyer arrangement desire to register with the service, the seller arrangement or buyer arrangement can execute a respective link, which can direct the facilitator arrangement to provide the sign-up form displays of FIGS. 10 and 11, respectively. As shown in FIGS. 10 and 11, the seller arrangements and buyer arrangements can provide the facilitator arrangement with information regarding the properties of the sellers and/or the sellers themselves, or information regarding the buyers can be generated, gathered or otherwise received by the facilitator arrangement. For additional or alternative sign-up displays that may be provided to a seller arrangement or buyer arrangement during registration, and for the seller arrangement or buyer arrangement to provide the facilitator arrangement with appropriate information, see FIGS. 12A, 12B and 12C. As indicated above, after the facilitator arrangement 16 receives the buyer information or the seller information, the facilitator arrangement can evaluate the information to at least partially ensure that the buyers are legitimate and qualified to purchase an indicated level of real estate, or to allow the facilitator arrangement to provide data related to the properties of the sellers.

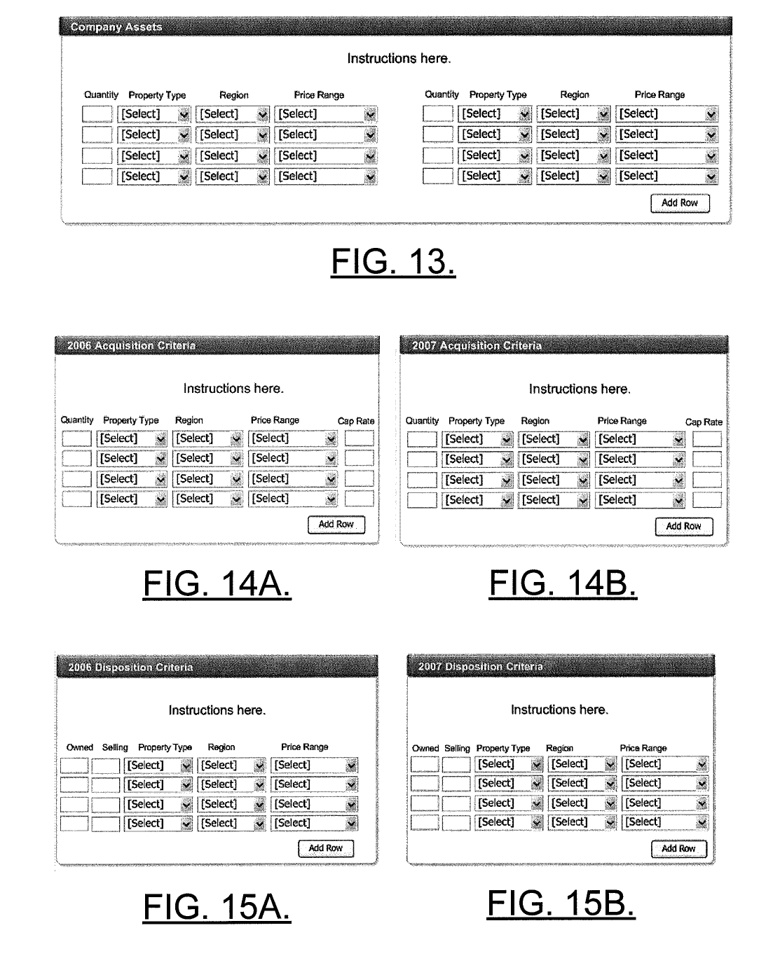

As indicated above and shown in FIG. 13, before, after or during registration, the participants may provide, to the facilitator arrangement 16, their asset base of properties including asset base criteria regarding those properties such as, for example, quantity, property type, region and/or price range. Additionally or alternatively, as shown in FIGS. 14A and 14B, participants may provide their acquisition criteria for a current time period (e.g., year) and/or one or more future time periods, where the acquisition criteria identifies criteria for properties the respective participants anticipate purchasing during the respective time period(s). Similarly, additionally or alternatively, as shown in FIGS. 15A and 15B, participants and sellers may provide their disposition criteria for a current time period (e.g., year) and/or one or more future time periods, where the disposition criteria identifies criteria for properties the respective participants anticipate selling during the respective time period(s).

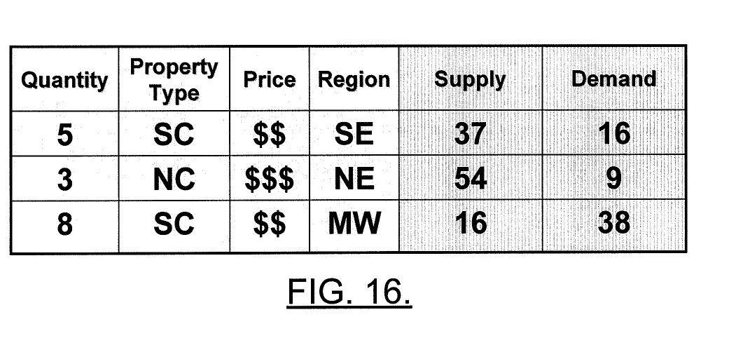

As shown in FIG. 16, for example, after providing information regarding an asset base, the facilitator arrangement 16 can provide, to a participant, real-time information regarding the number of properties having disposition criteria (other participants anticipate selling) matching the asset base criteria of properties in the respective participant's asset base (industry supply—shown in FIG. 16 as “supply”). In addition, and as also shown, the facilitator arrangement can provide, to a participant, real-time information regarding the number of properties having acquisition criteria (other participants anticipate purchasing) matching the asset base criteria (or even, within the asset base criteria, the disposition criteria) of properties in the respective participant's asset base (industry demand—shown in FIG. 16 as “demand”). Further, although not particularly shown in FIG. 16, the facilitator arrangement can provide, to the participant, current, real-time supply for properties with matching asset base criteria (for-sale—or for-sale or held—properties of other participants, and/or current-real time demand for actively-searched properties with matching asset base criteria.

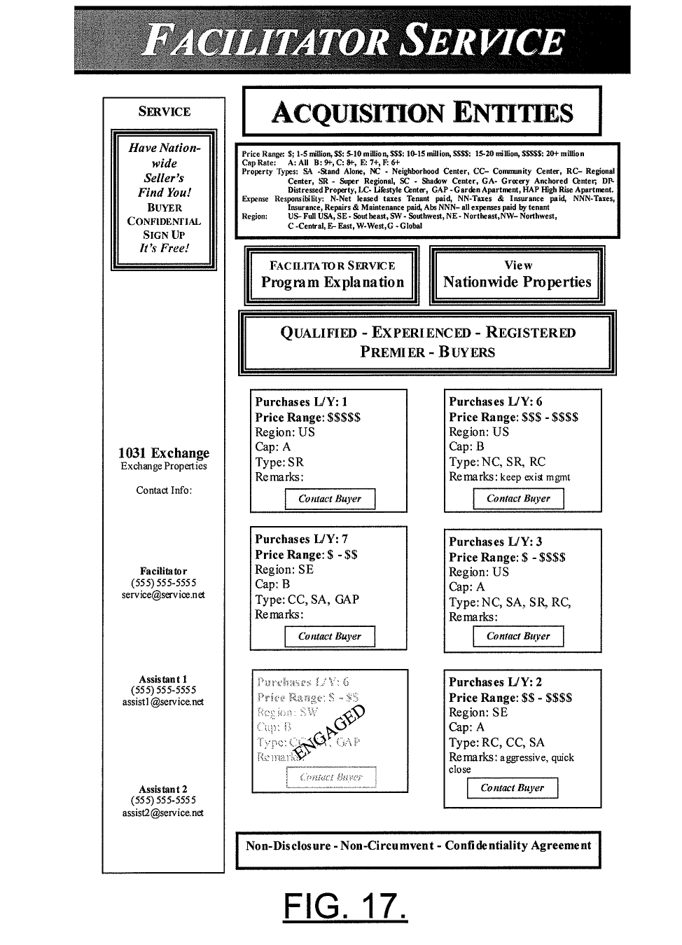

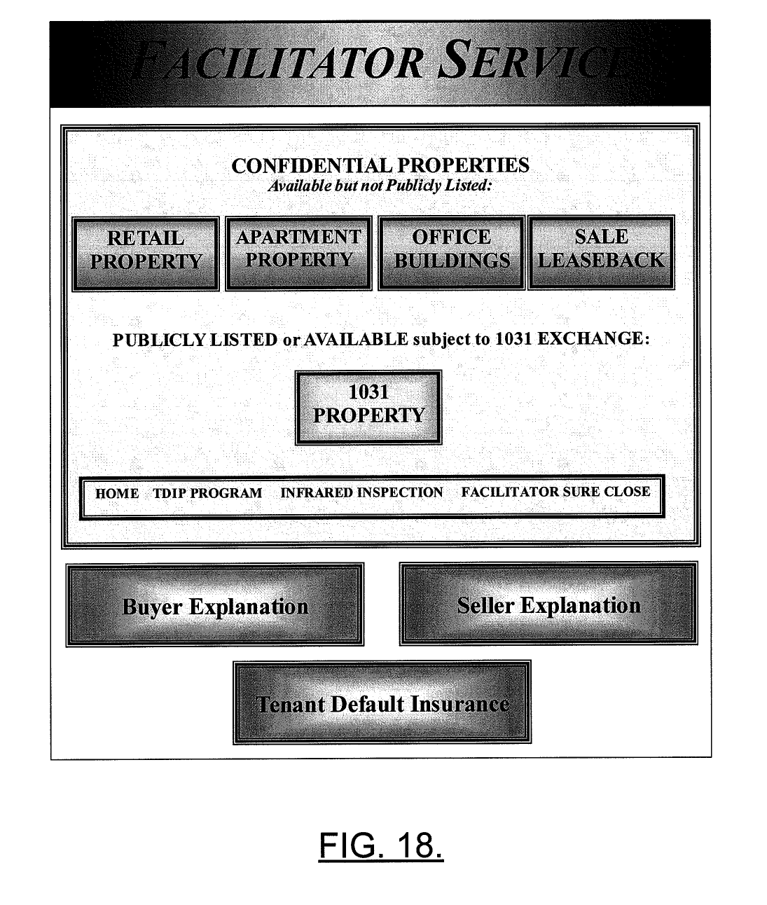

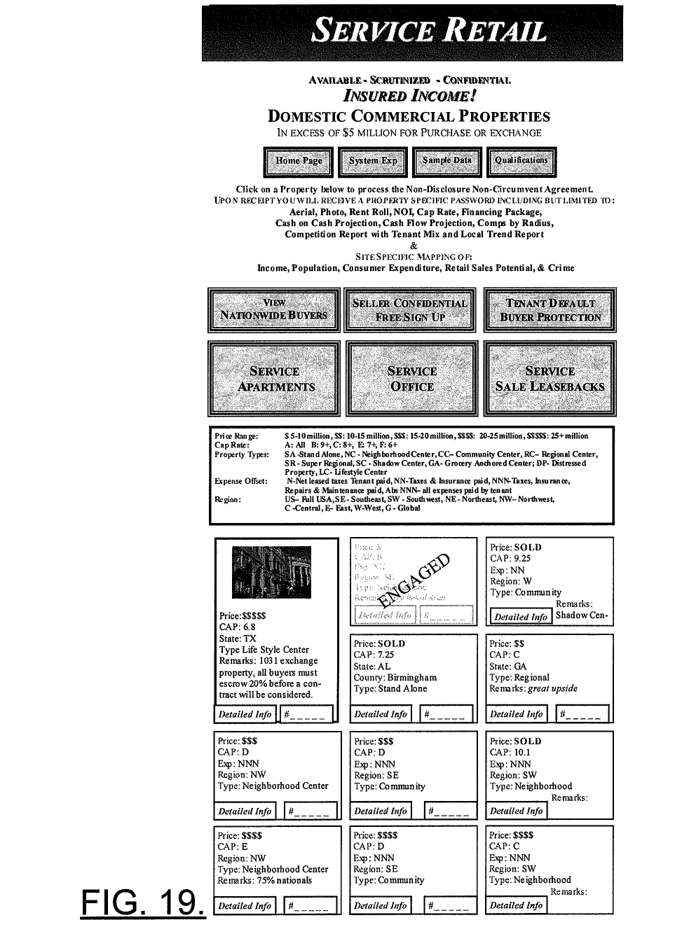

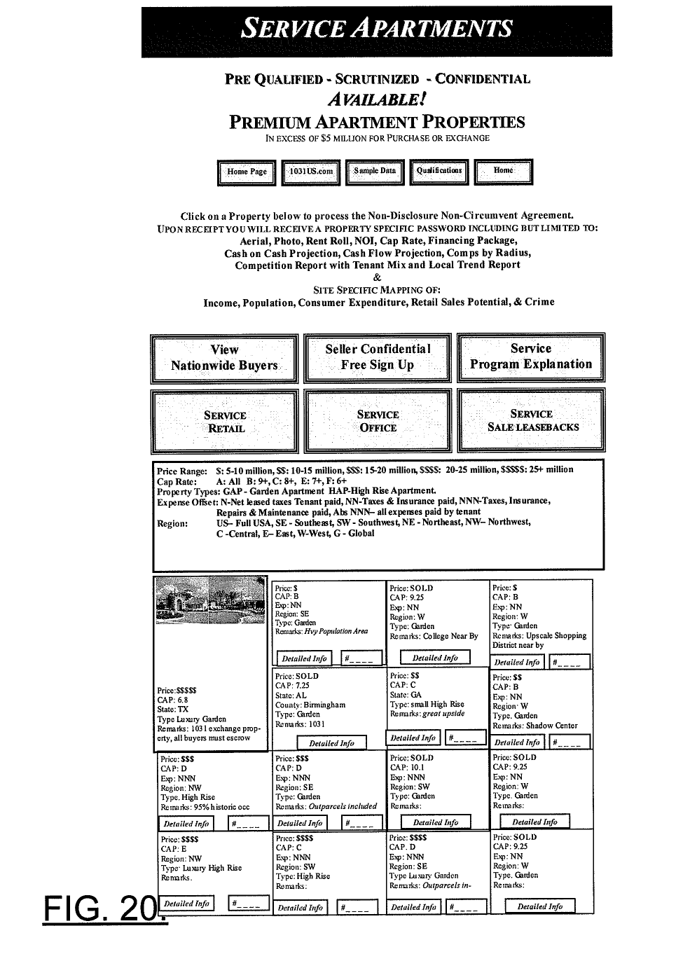

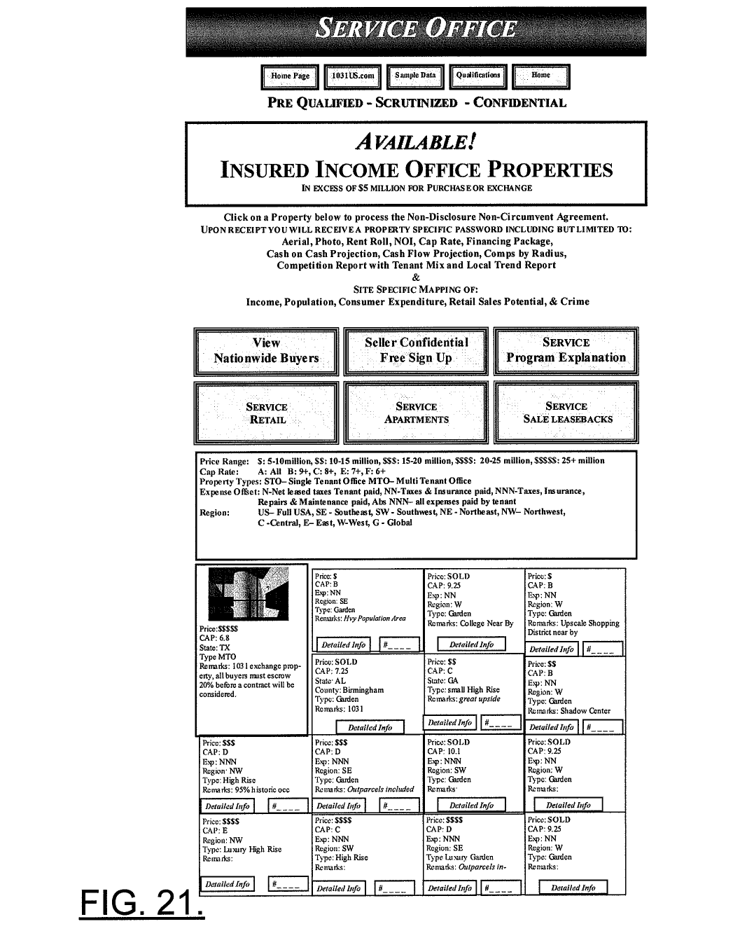

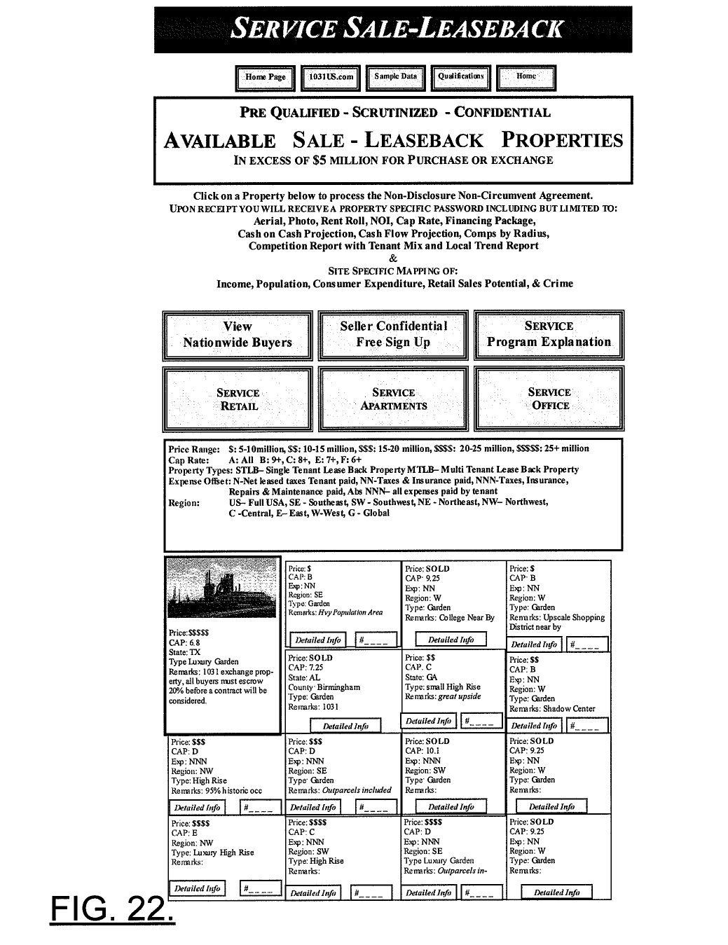

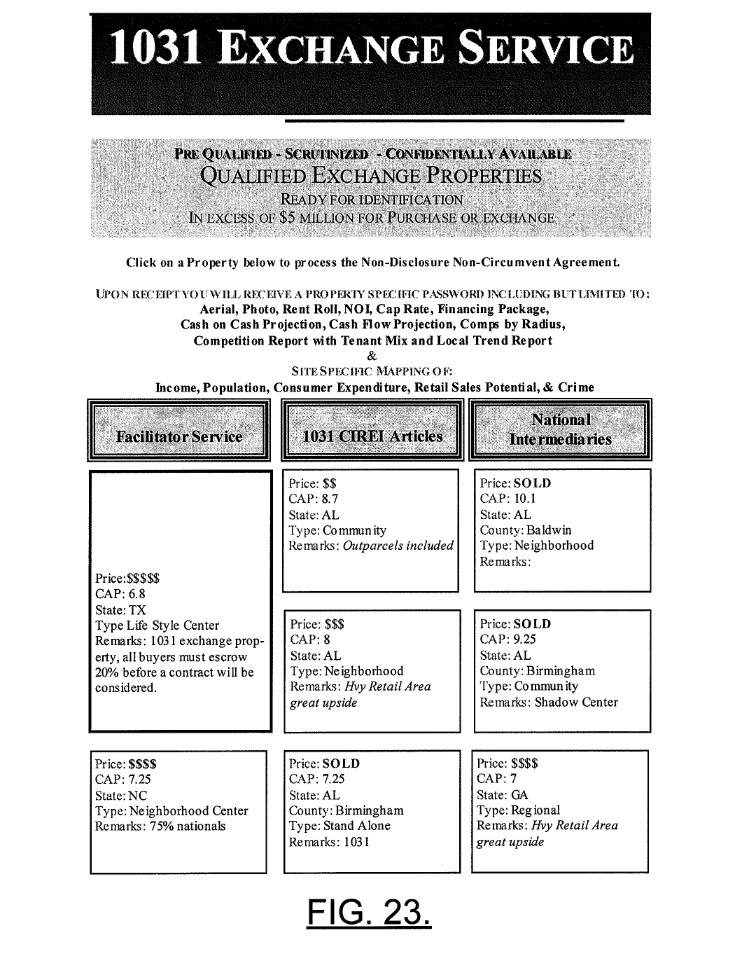

For buyer arrangements 12 and seller arrangements 14 registered with the service provided by the facilitator arrangement 16, as well as buyer and seller arrangements not registered with the service (if so desired), the facilitator arrangement provide details of buyers and properties (see block 34 of FIG. 3A). More particularly, as shown in FIG. 17, the facilitator arrangement can provide a display of acquisition entities (i.e., buyers), including a portion of the buyer information stored in the buyer database, the buyer information being sufficient to allow sellers to gauge an interest in the buyers. As shown in FIG. 18, the facilitator arrangement can provide a portal to details of confidential retail, apartment, office and sale-leaseback properties, as well as publicly listed or available properties subject to IRS 1031 tax deferred exchange. From the portal of details (as well as the portal of FIG. 6), the facilitator arrangement can provide displays of retail properties (FIG. 19), apartment properties (FIG. 20), office properties (FIG. 21), sale-leaseback properties (FIG. 22), 1031 properties (FIG. 23) and/or land, condominium complexes, industrial and/or non-real estate properties (not shown). Within each display, then, the facilitator arrangement can include details of respective properties, as well as a portion of the seller information stored in the property database, the portion of the information being sufficient to allow buyers to gauge an interest in the properties.

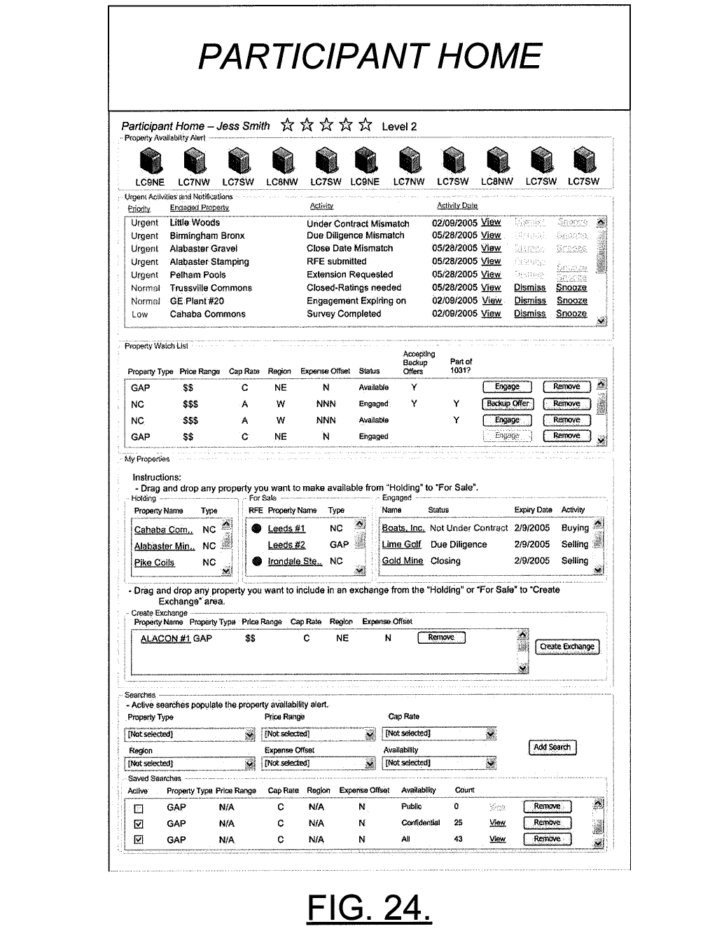

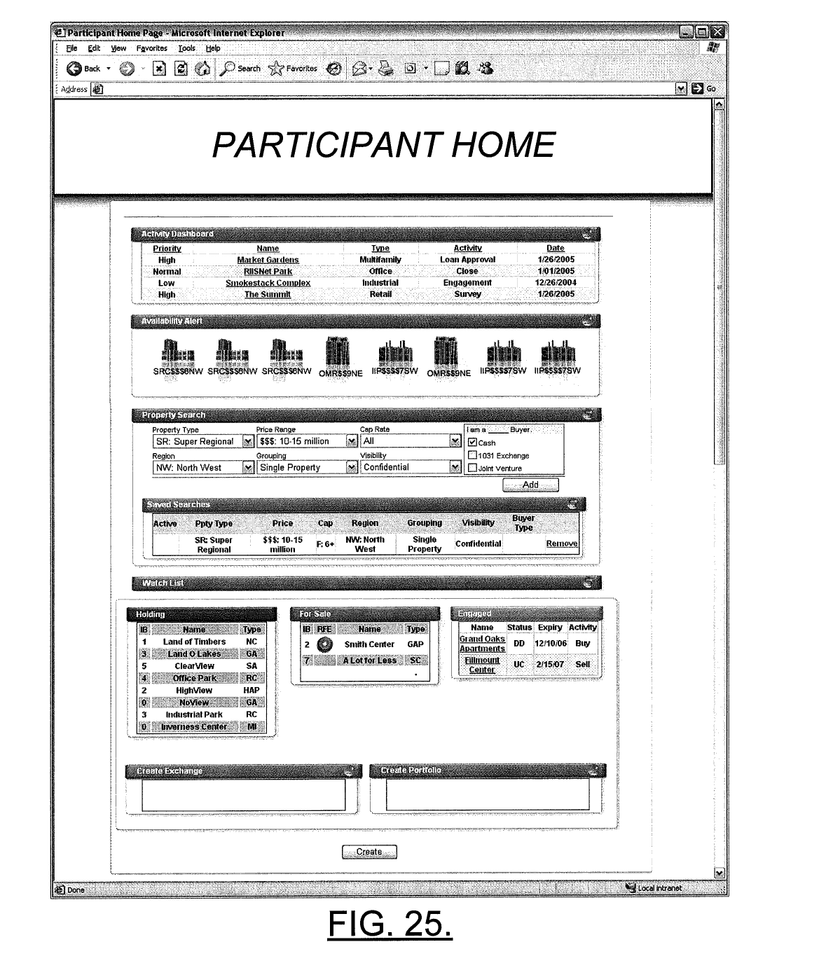

For buyer arrangements 12 and seller arrangements 14 registered with the service provided by the facilitator arrangement 16, the facilitator arrangement can provide a participant home page or display from which the respective party can manage their real-estate portfolio and activity with respect to the service, as shown in various exemplary embodiments in FIGS. 24 and 25. In this regard, the participant home page can include an availability alert portion (shown under the heading “property availability alert” in FIG. 24, and the heading “availability alert” in FIG. 25) including details of newly available properties (or buyers), and an activity dashboard portion (shown under the heading “urgent activities and notifications” in FIG. 24, and the heading “activity dashboard” in FIG. 25) including details of properties undergoing recent changes (e.g., lease review, completed appraisal, request for engagement—RFE, etc.) to their respective records in the property database. Additionally or alternatively, for example, the participant home page can include a property watch list including details of for-sale properties that meet the participant's predefined search criteria.

Also, for example, the participant home page can include a hold, sell, engaged property portion (shown under the heading “my properties” in FIG. 24) including separate details of properties of the participant in the hold state, for-sale and engaged states. As also shown, the engaged properties details can further include a status of the properties respective engagements, an expiration of the respective engagements, and/or whether the participant is the potential buyer or seller with respect to the respective engagements. In addition, for example, the participant home page can include a search matrix portion (shown under the heading “searches” in FIG. 24, and the heading “property search” in FIG. 25) from which the participant can search for-sale properties in the property database of the facilitator arrangement 16 based upon one or more search criteria (e.g., property type, square footage, geographic region, State, MSA, market size, price range, expense offset, cap rate, availability, average lease term remaining, percentage occupancy, percentage of national or credit tenants, etc.). Additionally, the search matrix portion may permit advanced searches whereby one or more criteria (e.g., price range, etc.) may be broadened, and/or one or more criteria (e.g., State, square footage, etc.) may be narrowed. The search criteria thereafter being used, for example, to specify the properties for which the participant receives availability alerts.

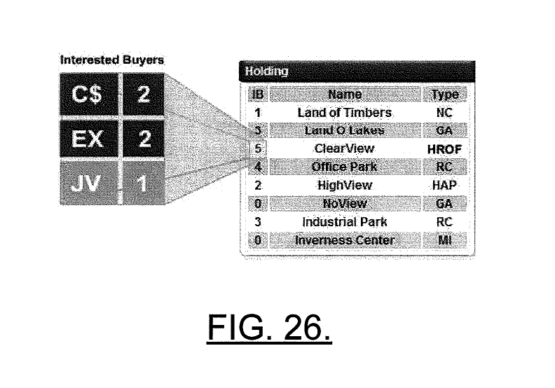

As shown in the exemplary embodiment of FIG. 25, the participant home page may additionally include, for properties in the hold (“holding”) and/or for-sale states, real-time (or otherwise) information indicating the number of buyers interested (interested buyers, or “IB”) in similar properties (e.g., current demand identified by matching active searches). And as further shown in FIG. 26, if so desired, the participant home page may also identify the types of interested buyers, such as cash (shown as “C$”), joint venture (shown as “JV”) or exchange-type buyers (shown as “EX”), which may be identified based on buyer information.

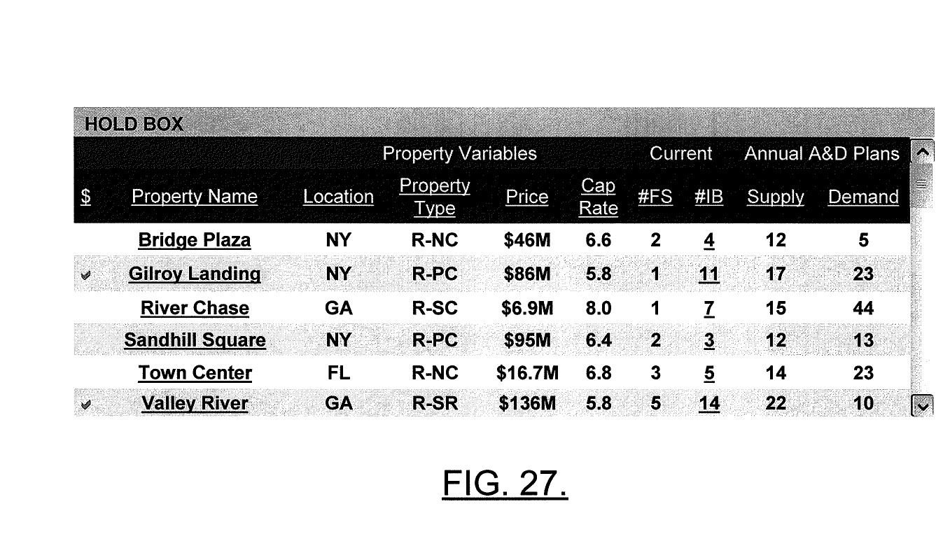

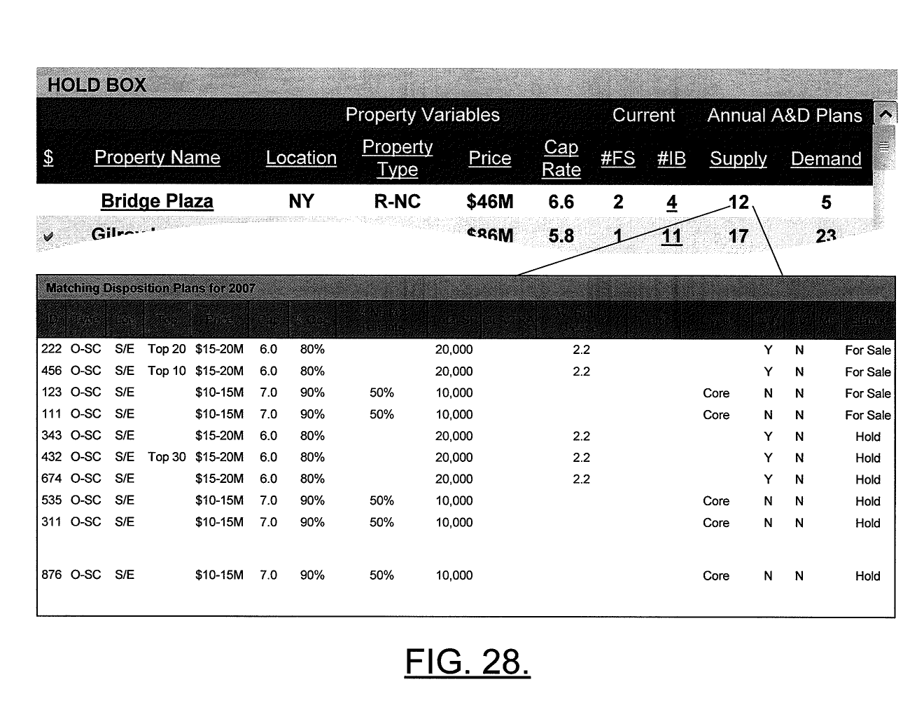

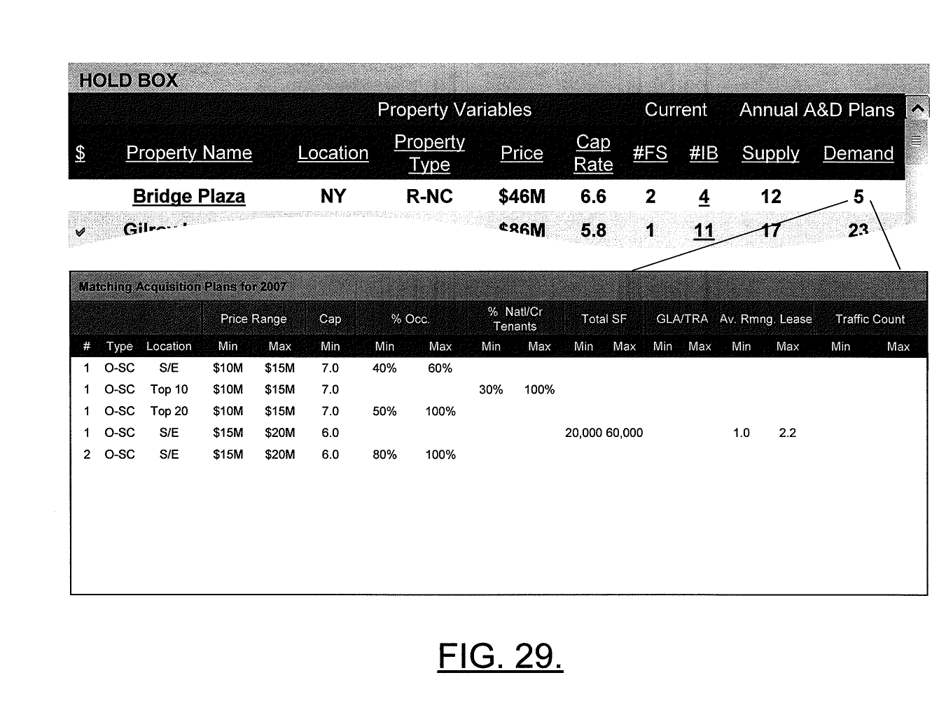

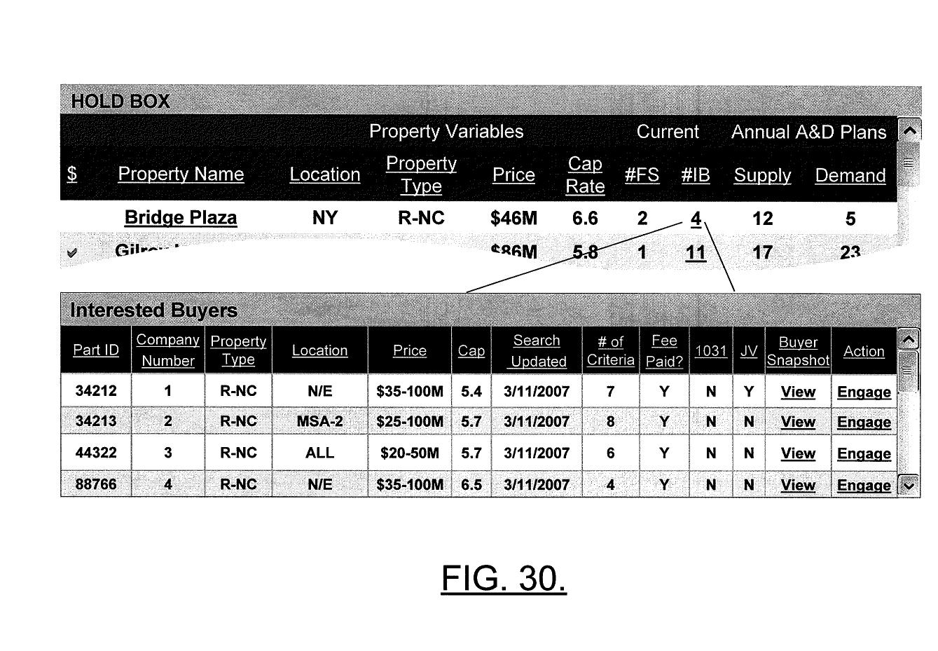

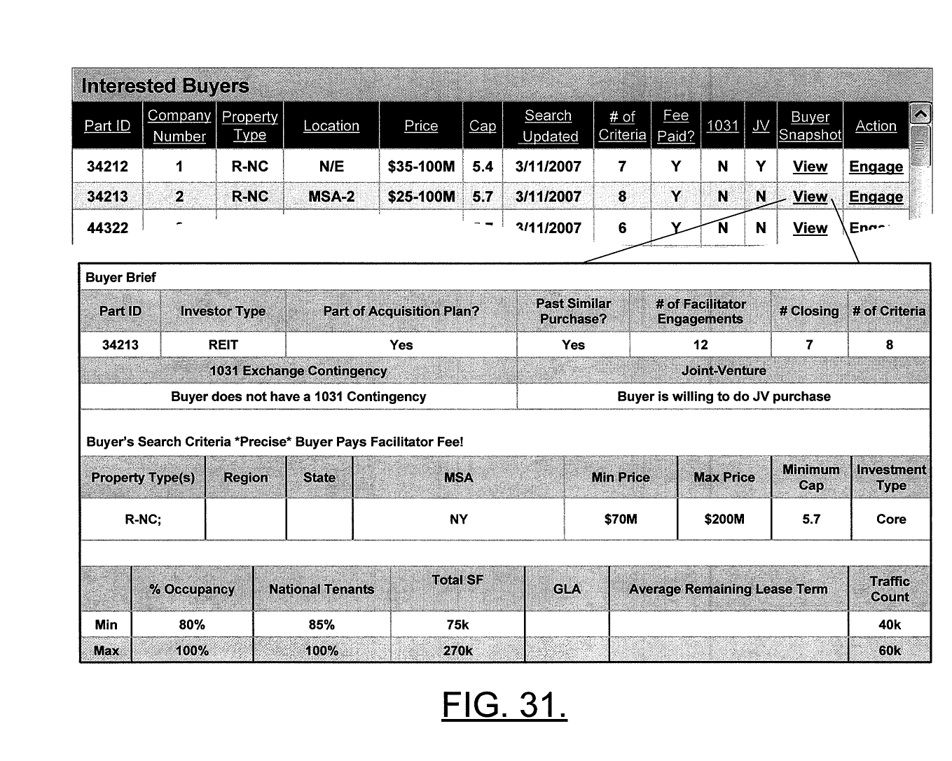

Further exemplary displays of the hold-state portion of a participant home page, including even more details of properties in the hold state is shown in FIGS. 27-31. As shown in FIGS. 27-30, the hold-state portion of a participant home page may include any of a number of different pieces of information related to properties of the participant including, for example, the name, location, property type, price, cap rate, current supply (#FS—number for sale), current demand (#IB), industry supply and/or industry demand. And as also shown in FIGS. 28-31, even further information may be provided to the participant as to at least a portion of the information related to respective properties, such as in response to a request for such information from the participant. For example, participant viewing the home page may select, for a particular property, one or more of industry supply, industry demand, current supply and/or industry demand to receive even further information regarding the properties being included making up such supply and/or demand values. This further information may be provided in a number of different manners, such as in a further portion of the participant home page, in a separate window or page overlaying a portion of the participant home page, or the like. As shown in FIGS. 28 and 29, for example, the participant may select industry supply or demand to receive further information regarding the properties making up the industry supply or demand, respectively. As shown in FIG. 30, for example, the participant may select current demand (#IB) to receive further information regarding the properties (or active searches) making up the current demand. In addition to information regarding the properties (or active searches) making up the current demand, the participant may receive even further information regarding the other participants actively searching for those respective properties (buyer snapshot or brief), as shown for example in FIG. 31.

Referring back to the exemplary participant home page of FIGS. 24 and 25, the participant home page can include an exchange matrix populator portion (shown under the heading “create exchange”) from which the participant can initiate a real estate exchange with respect to one or more properties of the participant. In this regard, the participant home page can be configured such that the participant can initiate a real estate exchange by dragging one or more properties from the details of held and/or sale properties (e.g., in the hold, sell, engaged property portion), and dropping those propert(ies) in the exchange matrix populator portion, the respective propert(ies) being identified for the purchase portion of an exchange by the dragging and dropping operations (see FIG. 4, block 56). To continue a real estate exchange, the participant (i.e., exchangor) can then be directed to an exchange portal (not shown).

Further, and although not shown, the participant home page can include a percentage-ownership offering (e.g., “TIC”) portion from which the participant can initiate an offering of percentage ownerships in one or more properties of the participant. In this regard, the participant home page can be configured such that the participant can initiate a percentage-ownership offering by dragging one or more properties from the details of held and/or sale properties (e.g., in the hold, sell, engaged property portion), and dropping those propert(ies) in the percentage-ownership offering portion, the respective propert(ies) being identified or otherwise selected for triggering the facilitator arrangement 16 to initiate a respective offering.

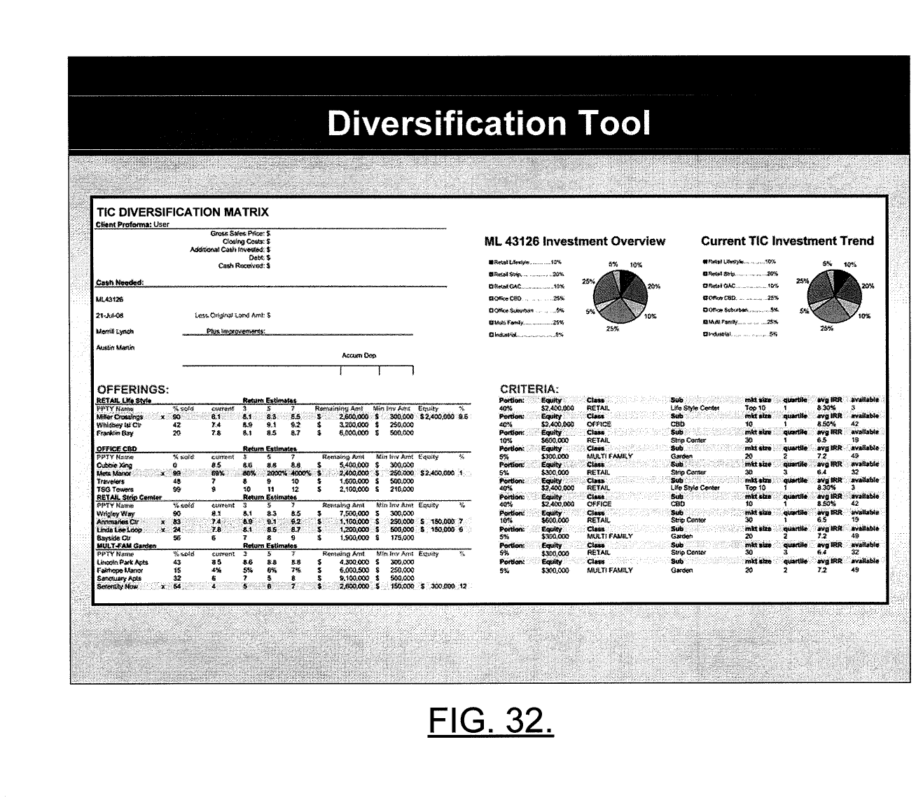

As shown in FIG. 32, to facilitate the participant initiating or otherwise effectuating a percentage ownership in one or more properties, the facilitator arrangement 16 can provide, to the participant, a diversification tool including a number of portions. In this regard, the diversification tool may include a criteria portion including, for example, acquisition criteria for one or more properties a percentage of which the participant is interested in purchasing, and may also include current supply for the respective properties (“available”). Similarly, the diversification tool may include an offerings portion including, for example, one or more properties for which percentage ownerships are currently being offered (either in an initial percentage-ownership offering or through a secondary market for percentage ownerships). The offerings portion may also include or otherwise identify one or more properties for which the respective participant has committed to purchase or has already purchased a percentage ownership. And further, the diversification tool may include portions (two being shown as “investment overview” and “investment trend” portions) tracking present and historical performance of the participants percentage-ownerships in various types of properties, which may facilitate the users understanding of diversification of their investments in such properties.

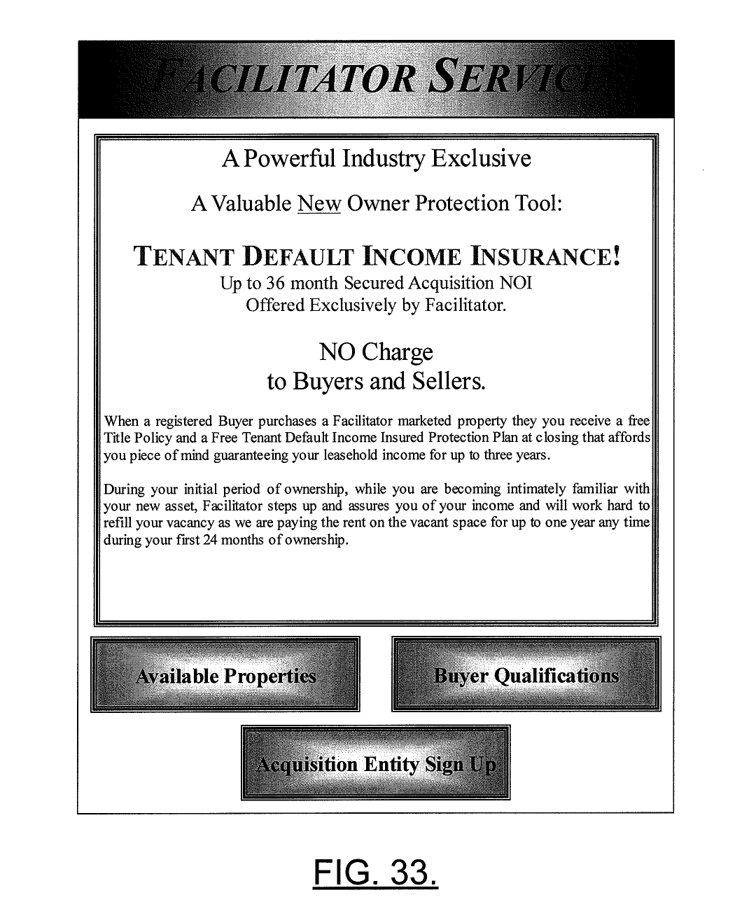

Also at the conclusion of the appropriate transactions, if so desired and offered by the facilitator, the facilitator can provide a tenant default insurance policy (see block 54 of FIG. 3B and block 86 of FIG. 5). In this regard, as the buyer arrangements 12 and seller arrangements 14 engage the service offered by the facilitator arrangement 16, the facilitator arrangement can provide the buyer arrangements and seller arrangements with information regarding such a policy, as shown in the display of FIG. 33. And by providing such information, the facilitator arrangement can facilitate the buyer arrangements and seller arrangements registering with the service offered by the facilitator arrangement, and concluding a transaction while engaging the service.

As will be appreciated, the service of the facilitator arrangement 16 described herein can be provided in a number of different contexts relating to real estate, from commercial to residential real estate. It should be understood, however, that the service can generally be provided in any of a number of different contexts involving a buyer and a seller of a good. For example, the service can be provided by the facilitator arrangement in the context of an auction offering of a good by a seller to a number of buyers, such as in the context of an online auction (e.g., eBay). Also, effectuating real estate transactions involving percentage ownerships (e.g., TIC ownerships) in properties described herein can be provided in conjunction with tenant default insurance. It should be understood, however, that such transactions involving percentage ownerships can be provided independent of such tenant default insurance, without departing from the spirit and scope of the present invention.

According to one aspect of the present invention, all or a portion of the system of the present invention, such as all or portions of the buyer arrangement 12, seller arrangement 14 and/or facilitator arrangement 16, generally operates under control of a computer program product. The computer program product for performing the methods of exemplary embodiments of the present invention includes a computer-readable storage medium, such as the non-volatile storage medium, and computer-readable program code portions, such as a series of computer instructions, embodied in the computer-readable storage medium.

In this regard, FIGS. 3A, 3B, 4, and 5 are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts.

Accordingly, blocks or steps of the control flow diagrams support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
maintaining a database including information associated with a real-estate portfolio of an entity, the real-estate portfolio including one or more real-estate properties;
receiving selection of a property in the portfolio for offering one or more percentage ownerships thereof;
initiating an offering of one or more percentage ownerships of the respective property in response to the selection, initiating an offering including automatically notifying one or more other entities of the offering; and
receiving commitments from one or more other entities regarding respective percentage ownerships of the property to thereby facilitate the entity and one or more other entities concluding a percentage-ownership transaction regarding the property,
wherein the offering is retractable by the entity until the one or more other entities commit to purchase, in the aggregate, a minimum percentage ownership of the respective property.

2. A method according to claim 1, wherein maintaining a database comprises maintaining a database including information associated with a real-estate portfolio including one or more real-estate properties selectable for offering one or more of the respective properties for sale in their respective entireties or in percentages, or for exchange.

3. A method according to claim 1, wherein receiving selection comprises receiving selection of a property for offering one or more percentage ownerships thereof as a tenancy-in-common.

4. A method according to claim 1, wherein receiving commitments comprises receiving commitments up to a set maximum percentage, the set maximum percentage being less than one-hundred percent.

5. A method according to claim 1, wherein receiving selection comprises receiving selection based on acquisition criteria received from, and aggregated across, a plurality of other entities, the acquisition criteria characterizing one or more properties the respective other entities anticipate purchasing.

6. A method according to claim 1, wherein the respective property comprises an income-producing property including one or more tenants, wherein initiating an offering comprises initiating an offering further including an offer of insurance for a period of time against a loss of income due to a default of one or more of the tenants if the entity and one or more other entities conclude the percentage-ownership transaction.

7. A method according to claim 6 further comprising:
entering into an agreement with each of the one or more other entities if the entity and one or more other entities conclude the percentage-ownership transaction, the agreement defining a default of at least one of the one or more tenants of the property based upon a financial inability of at least one tenant to pay rent; and
providing a financial benefit to one or more of the other entities in accordance with the agreement, and in response to a loss of income due to default of at least one of the one or more tenants of the property.

8. A method according to claim 7, wherein entering into an agreement comprises entering into an agreement that also defines a level of protection, the level of protection having been determined based upon a percentage of an income received by the entity from the property.

9. A method according to claim 7, wherein providing a financial benefit to the entity in accordance with the agreement comprises:
determining and remitting a financial benefit to the entity if a tenant defaults in accordance with the agreement, the financial benefit being determined based upon a rental income due from the defaulting tenant.

10. A method according to claim 7, wherein entering into an agreement comprises entering into an agreement with the entity without interaction with the at least one tenant of the property.

11. A method according to claim 7, wherein entering into an agreement comprises entering into an agreement also defining a level of protection, the level of protection having been determined based upon an operating income of the property at a conclusion of the transaction affecting ownership.

12. An apparatus comprising:
a processor configured to maintain a database including information associated with a real-estate portfolio of an entity, the real-estate portfolio including one or more real-estate properties,
wherein the processor is configured to receive selection of a property in the portfolio for offering one or more percentage ownerships thereof;
wherein the processor is configured to initiate an offering of one or more percentage ownerships of the respective property in response to the selection, including being configured to automatically notify one or more other entities of the offering, the offering being initiated to facilitate receiving commitments from one or more other entities regarding respective percentage ownerships of the property to thereby facilitate the entity and one or more other entities concluding a percentage-ownership transaction regarding the property,
wherein the offering is retractable by the entity until the one or more other entities commit to purchase, in the aggregate, a minimum percentage ownership of the respective property.

13. An apparatus according to claim 12, wherein the processor being configured to maintain a database includes being configured to maintain a database including information associated with a real-estate portfolio including one or more real-estate properties selectable for offering one or more of the respective properties for sale in their respective entireties or in percentages, or for exchange.

14. An apparatus according to claim 12, wherein the processor is configured to receive selection of the property for offering one or more percentage ownerships thereof as a tenancy-in-common.

15. An apparatus according to claim 12, wherein the processor is configured to initiate the offering to facilitate receiving commitments up to a set maximum percentage, the set maximum percentage being less than one-hundred percent.

16. An apparatus according to claim 12, wherein the processor is configured to receive selection of the property based on acquisition criteria received from, and aggregated across, a plurality of other entities, the acquisition criteria characterizing one or more properties the respective other entities anticipate purchasing.

17. An apparatus according to claim 12, wherein the respective property comprises an income-producing property including one or more tenants, wherein the processor being configured to initiate an offering includes being configured to initiate an offering further including an offer of insurance for a period of time against a loss of income due to a default of one or more of the tenants if the entity and one or more other entities conclude the percentage-ownership transaction.

18. A computer program product comprising at least one computer-readable storage medium having computer-readable program code portions stored therein, the computer-readable program code portions comprising:
a first executable portion configured to maintain a database including information associated with a real-estate portfolio of an entity, the real-estate portfolio including one or more real-estate properties;
a second executable portion configured to receive selection of a property in the portfolio for offering one or more percentage ownerships thereof; and
a third executable portion configured to initiate an offering of one or more percentage ownerships of the respective property in response to the selection, including being configured to automatically notify one or more other entities of the offering, the offering being initiated to facilitate receiving commitments from one or more other entities regarding respective percentage ownerships of the property,
wherein the offering is retractable by the entity until the one or more other entities commit to purchase, in the aggregate, a minimum percentage ownership of the respective property.

19. A computer program product according to claim 18, wherein the first executable portion is configured to maintain a database including information associated with a real-estate portfolio including one or more real-estate properties selectable for offering one or more of the respective properties for sale in their respective entireties or in percentages, or for exchange.

20. A computer program product according to claim 18, wherein the second executable portion is configured to receive selection of a property for offering one or more percentage ownerships thereof as a tenancy-in-common.

21. A computer program product according to claim 18, wherein the third executable portion is configured to initiate the offering to facilitate receiving commitments up to a set maximum percentage, the set maximum percentage being less than one-hundred percent.

22. A computer program product according to claim 18, wherein the second executable portion is configured to receive selection based on acquisition criteria received from, and aggregated across, a plurality of other entities, the acquisition criteria characterizing one or more properties the respective other entities anticipate purchasing.

23. A computer program product according to claim 18, wherein the respective property comprises an income-producing property including one or more tenants, wherein the third executable portion is configured to initiate an offering further including an offer of insurance for a period of time against a loss of income due to a default of one or more of the tenants if the entity and one or more other entities conclude the percentage-ownership transaction.
